(19) United States
(12) Patent Application Publication
(10) Pub. No.: US 2023/0026644 A1
(43) Pub. Date: Jan. 26, 2023

(54) METHOD AND SYSTEM FOR PROCESSING PRODUCTS

(71) Applicant: Weber Maschinenbau GmbH Breidenbach, Breidenbach (DE)

(72) Inventors: Steffen Zecher, Staufenberg (DE); Patrick Schneider, Lollar (DE); Ingo Rother, Breidenbach (DE); Joachim Schaub, Hatzfeld-Reddighausen (DE); Thomas Nispel, Dautphetal (DE); Jörg Schmeiser, Wiggensbach (DE); Pedro Ruedin, St. Gallen (CH)

(21) Appl. No.: 17/956,981

(22) Filed: Sep. 30, 2022

Related U.S. Application Data
(63) Continuation of application No. 17/624,538, filed on Jun. 29, 2022.

(30) Foreign Application Priority Data
Jul. 4, 2019 (DE) 102019118048.1
Oct. 10, 2019 (DE) 102019127275.0

(51) Int. Cl. A22C 17/00

(52) U.S. Cl. CPC A22C 17/002; A22C 17/0033; A22C 17/008; A22C 17/0093

(57) ABSTRACT

A system for processing food products to be sliced or to be divided comprises a processing line that comprises a plurality of work stations and a single-track or multi-track transport device for transporting the products along a transport path from work station to work station, wherein at least one of the work stations has a means for determining at least one parameter, and wherein the means is connected to an evaluation and control device that is configured to generate a control signal in dependence on the at least one parameter.

### METHOD AND SYSTEM FOR PROCESSING PRODUCTS

The invention relates to a method for processing food products to be sliced and/or to be divided, in particular for processing fresh meat and/or bacon, in a processing line comprising a plurality of work stations, wherein the products are transported along a transport path on one track or multiple tracks from work station to work station.

Furthermore, the invention relates to a system for processing products, in particular for processing fresh meat.

To process products and in particular fresh meat, a large number of different processing steps are often necessary to achieve the desired result. Such a processing can, for example, be directed towards producing portions from one or more slices from a natural or fresh meat product. In addition to the production of the slices and the creation of the portions, further previous processing steps are often necessary in this respect to prepare the products for the cutting. Accordingly, in such methods for processing products or in systems for such a processing, the products can be transported along a transport path and can be processed stepwise at a plurality of work stations, wherein each of the work stations is provided and configured for at least one specific processing step. In this respect, the transport path can generally also be formed with a plurality of tracks to generally be able to increase the product throughput by a parallel and simultaneous processing of a plurality of products.

However, the operation and the control of such a processing line are often extremely complex since each of the plurality of work stations has to be specially operated and set. Furthermore, it also has to be considered in the control that a specific setting of a work station can have a direct influence on the processing of the products at the further work stations, in particular at work stations arranged downstream, due to the step-wise processing. This requires a high level of expertise and experience of a user in the operation of each of the work stations and a deep understanding of their interaction in the processing line in that each of the work stations, for example, has to be precisely set to the properties of the products to be processed of a subsequent batch before the start of operation. In particular on a flexible use of the processing line for a processing of products of different types or kinds, for which a different processing and possibly even different processing steps may be required, a large amount of information has to be considered in the control.

Furthermore, a user also has to be able to recognize and eliminate any incorrect settings, which may lead to a deficient processing of the products, during the operation. This first requires an elaborate and detailed product examination during or after the processing to determine such defects. A user also has to be able to associate these possibly determined defects in the processed products with a possible incorrect setting of one of the work stations and to be able to optimally correct their setting while considering the influence on further work stations. In particular in the case of more complex problems or generally due to the interaction of the settings of the individual work stations with one another, this can even in the case of experienced users result in different settings of different work stations having to be changed a multiple of times on a trial basis and the result then having to be checked again. However, considerable operating disturbances and possibly an undesirably large product waste can thereby occur if the processing does not take place in an optimal manner over a longer period of time.

The processing of fresh meat is furthermore particularly challenging since in addition to the large number of precise processing steps that are usually necessary, the processing of fresh meat is subject to strict specifications, wherein in particular strict hygiene regulations as well as temperature specifications have to be observed under which the processing may take place. In particular the processing of fresh meat along a processing line thus often requires a high level of expertise and experience of a user to be able to optimally set each of the work stations and, if necessary, to be able to flexibly adapt the settings during operation while considering the applicable specifications.

It is therefore an object of the invention to provide a possibility of simplifying the operation of such a processing line and of being able to perform said operation adapted as optimally as possible to a specific product without requiring special expertise or many years of experience of a user for this purpose.

This object is satisfied by the method comprising the steps of claim 1 and in particular in that at least one parameter is determined at least one work station and is considered at another position of the processing line.

Since the parameter determined at a work station is considered at another position of the processing line, a linking of the individual work stations with one another and thus an intelligent operation of the processing line can be achieved. Thus, it is, for example, possible to consider the parameter determined at a work station such that the following processing step is adapted in dependence on the determined parameter. Information that was obtained on the product by means of the parameter can thus be used to adapt the following processing step so that it can be performed specifically and optimally adapted to the respective product.

Equally, the parameter can also be considered retroactively so that a previous processing step is adapted on the basis of the parameter determined at the work station. It can thereby be achieved that a non-optimal pre-processing of the products recognized by means of the parameter is adapted for the following products so that they reach the respective work station in the desired state. The parameter can thus provide a measure of the results of previous processing steps to be able to check these processing steps during the operation and, if necessary, to be able to adapt or optimize them.

The determination of at least one parameter at one work station and its consideration at another position of the processing line allows a particularly flexible processing of the products since the consideration of the parameter does not remain restricted to the respective work station, but is also considered in the further or other processing of the products. In general, the processing can thus even be specifically oriented towards individual products, also within a batch, since the parameter can be determined for each product and can be specifically considered for each product.

The possibilities that are described above and in the following embodiments and that result from the consideration of a determined parameter at another position of the processing line are not limited to possible adaptations or changes taking place solely based on a single determined parameter. Rather, a plurality of parameters can also be considered at one position of the processing line, wherein the parameters considered can generally have been determined at one or more of the work stations. It is in particular possible that a processing step is, for example, adapted in dependence on a single parameter or a plurality of parameters that were determined at a respective work station or at a plurality of work stations. A consideration of parameters that were determined at the respective work station carrying out the processing step itself is also not precluded in this respect. In this regard, all the measures described above and in the following can generally take place both in dependence on one parameter or a plurality of parameters.

The determined parameter can be product-related and can relate to a property of the product, for example, its size, weight, shape, or temperature. Alternatively or additionally, a machine-related parameter can also be determined that can in particular relate to a value of a control variable of the work station. For example, a set cooling temperature can be determined at a work station when the products are cooled there during the processing.

The determined parameter can in particular be considered at another work station so that, for example, a control variable of a work station arranged upstream and/or downstream is changed. In this respect, it is also possible that the settings of different work stations are coupled so that a parameter-related change of a control variable of one work station directly also causes adaptations of control variables of other work stations. This can in particular take into account the complex interaction of the work stations with one another on the processing of the products and can ensure that further processing steps are not negatively influenced by a setting of one of the work stations.

Possible embodiments of the invention can be seen from the dependent claims, from the description, and from the drawings. The following statements in this respect generally relate to both the method in accordance with the invention and to the subsequently explained system in accordance with the invention for processing products that is preferably configured to perform the method in accordance with the invention. Accordingly, the mentioned further developments of the invention also relate to both the method in accordance with the invention and the system in accordance with the invention for processing products.

The parameter can relate to a property of the product. Thus, the size of a product, its weight, shape, or temperature can be determined, for example. The temperature development with respect to a surface of the product can likewise be determined in order, for example, to detect deviations from a constant cooling or temperature. The surface property or surface structure of a product or a degree of freezing of a surface can also be determined and considered in the further processing.

A product-related parameter can also represent a product property or be derived from a product property so that a value can, for example, be associated with a specific type of surface property or shape of a product. However, it is also possible for the parameter to be determined as a tuple of values, for example, to be able to indicate a temperature development at specific spacings at the surface of the product along one direction by the parameter and to be able to consider said temperature development at another position on the processing line.

The parameter can also relate to a control variable of the one work station. A control variable in this respect refers to a controllable or settable variable of the respective work station so that the parameter can in particular be a value to which the respective control variable can be set or to which it is set.

Such a control variable can, for example, be a basic machine setting, such as its bandwidth, stops in the sense of limit values, as well with respect to movable components and as to other control variables like a cooling temperature, or forces applied during the processing and their direction. Equally, currently set desired value specifications can be determined as parameters and can be considered in the further processing of the products.

Provision can be made that a further processing step that is not regularly performed takes place on the basis of the parameter. If it is determined on the basis of the parameter that a product has not been processed as desired or that the product is not usable for a further processing or requires a further processing not originally provided for this purpose, a further processing step can be interposed. For this purpose, the product can, for example, be manually treated or can be automatically guided via a path arranged next to the transport path to a work station not associated with the processing line and is specifically treated there. Thereupon, the product can e.g. be fed back to the processing line at an adequate position or can, in principle, be provided for a modified processing and can be fed to another processing process.

Accordingly, the parameter can also be made available to an ejection mode or to an ejection algorithm and can act as an input parameter thereof, with a sorting out of the product or an initiation of a separate processing taking place on the basis of the calculation of said input parameter.

In some embodiments, a signal perceptible to a user can be generated in dependence on the parameter. Such a signal can be visually or acoustically perceptible so that a user is made aware of it. For example, an alarm can be generated that indicates the necessity for an intervention in the operation and in particular for an adaptation of the processing process. In this respect, such alarm or warning signals, for example in the form of an alarm sound, a sound sequence or an illuminating lamp, can be generated directly at a respective work station at which an adaptation or an intervention is necessary. This can facilitate the operation of the processing line to the effect that a user is informed of an incorrectly set work station and can adapt it without having to check the process himself and having to independently associate or locate work stations that are not optimally set. In general, such a signal can also be generated by an external device or system, which is connected to the processing line, and can be triggered in a control room, for example.

Provision can also be made that the signal perceptible to a user is generated as a display on a screen, said display, for example, being able to indicate a specific indication of a malfunctioning work station or a direct instruction or setting recommendation for the adaptation to be made. The user can thus receive direct information on the control or adaptation of the processing line so that he only has to be familiar with the basic setting and operation of the individual work station. This can, for example, take place at a central control that can in particular be arranged in the direct vicinity of the screen or whose operation can take place directly at the screen.

Due to such a display of direct instructions for the control of the processing line, a user furthermore does not himself have to keep an eye on the interaction of the individual work stations with one another and thus on the effects of an adaptation of a control variable at a work station on the further processing process since this can already be considered in the evaluation of the parameter. Due to such a communication with the user, the operation of the processing line can thus be considerably facilitated so that a processing of the products as desired can also be ensured during as permanent an operation as possible when the system is operated by a user without many years of experience.

Provision can be made that the parameter determined at the one work station is considered in the processing of the products at least one other work station. This considering can in this respect take place both at a work station arranged upstream with respect to the transport path and at a work station arranged downstream with respect to the transport path. For example, in dependence on the parameter, a signal can for this purpose be generated on the basis of which a user performs an adaptation at one of the work stations. Provision can also be made that the parameter is automatically evaluated and, if necessary, a control variable is adapted at another work station to adapt the processing at this work station while considering the information obtained by means of the parameter.

If the consideration of the determined parameter takes place at a work station arranged upstream, an adaptation can, for example, take place if products do not arrive optimally prepared at the work station at which the parameter is determined. This retroactive consideration thus in particular enables an optimized operation in that a check of the previous processing steps takes place by means of the determined parameter and are adapted in an optimizing manner.

The consideration of the parameter at a work station arranged downstream further enables a product-specific operation even within one batch. First, basic settings of the work station arranged downstream can thus, for example, be adapted in the event of a batch change detected on the basis of the parameter in order to set them to the product type processed in the respective batch. Furthermore, it is, however, also possible to individually determine the parameter for each of the products to be processed so that the parameter for the respective, specific product can be considered at a work station arranged downstream and the processing can take place in a product-specific manner. A particularly flexible processing can thereby be achieved during which the specific properties of individual products are considered.

It is generally also possible for the parameter to be considered at a plurality of the other work stations. Based on the parameter, an adaptation can thus in particular take place both at a work station arranged upstream and at a work station arranged downstream. Subsequent products can thereby arrive optimally at the work station at which the parameter is determined, while a product-specific subsequent processing can also take place.

However, on such a consideration of the parameter at another work station, it is not absolutely necessary that an adaptation of a work station takes place directly in response to each parameter determination. Rather, the parameter can also only serve for a check of the settings of the work stations, wherein they are not adapted if the parameter is within a predefined or predefinable range.

In some embodiments, an instruction for adapting at least one control variable of at least one other work station can be generated in dependence on the parameter. This instruction can, for example, be transmitted to a user so that he can make the necessary adaptation of the control variable. In general, it is, however, also possible for the instruction to be transmitted directly to the respective work station and for the adaptation to be made automatically. Due to such a direct transmission, an automatic operation can be achieved so that a user only has to monitor it without having to make adaptations himself or having to be familiar with the settings of all the work stations.

In addition to an instruction for adapting a control variable that changes the processing of the products at the respective work station, a suspension of the processing at this work station can also take place through such an instruction. Consequently, an instruction can also be generated to set a control variable of a work station to a zero value so that the products are led or guided through this work station without any processing taking place. Such settings can also in particular take place on a product-specific basis, for example, if it is determined on the basis of the parameter that a processing of a specific, individual product is not necessary or possible at one of the work stations.

Provision can be made that an instruction for suspending the processing at another work station is generated in dependence on the parameter. This instruction can therefore be specifically aimed at not processing a specific product or products of a specific type at one of the work stations. As explained above, this can, for example, take place by an instruction for setting a control variable to a zero value so that the products are merely transported or guided through the work station without any processing taking place there.

If the processing is suspended at a work station, a forwarding of the product from one work station to a work station that is not arranged directly downstream, for example to the next-but-one work station, can thus effectively take place. In this respect, the suspension of the processing does not necessarily have to be provided at a work station arranged downstream or arranged directly downstream of the work station at which the parameter is determined. Rather, the processing at any desired work station can, if necessary, be suspended on the basis of the parameter. For example, the processing can also be suspended at a work station arranged upstream if it is recognized that even without a processing at this work station the products are optimally prepared for the processing step at the work station at which the parameter is determined.

The possibility of such a suspension of the processing at specific work stations allows a flexible adaptation of the processing line so that, for example, different types of products can be processed and the processing steps can be adapted to the respective product without a conversion of the processing line being necessary. In principle, different products can thus also be simultaneously processed in a multi-track processing line, wherein the processing of the products in each track can be individually adapted to the respective product in that the processing is, for example, suspended at one of the work stations in one of the tracks. Furthermore, it is also possible to perform the processing of the products within a batch and thus a product type specifically adapted to the individual product.

In some embodiments, an instruction for adapting the transport path can be generated in dependence on the parameter. Due to such an adaptation of the transport path, a specific product can, for example, be moved past a work station in that it is transferred to a functional path arranged next to the transport path. Accordingly, no processing of the product takes place at this work station, wherein the product can, if necessary, subsequently be fed back to the transport path again and can be processed further at a subsequent work station. In particular if the products are guided through the work stations in rapid succession to achieve a high product throughput, such a guiding past can be provided for specific products so that no variable adaptation has to take place that leads to a suspension of the processing and that would have to be reversed for the directly subsequent product.

An adaptation of the transport path can also result in the product, for example likewise on a functional path arranged next to the transport path, being returned to a work station arranged upstream and being processed there again. Unsatisfactorily processed products can then be reprocessed to achieve the desired result so that a consistently high quality of the processing can be ensured. Such a return to a work station arranged upstream can in this respect, if necessary, also take place a multiple of times until the desired processing is determined.

Furthermore, it is possible that a product is guided by an adaptation of the transport path into a removal and/or checking region to be checked there by a user. The user can thereupon, for example, feed the product to the processing line again at a processing step that is deemed necessary or can earmark the product for rejection due to a lack of quality or processing. It is likewise possible that the removal and/or checking region directly corresponds to a reject zone so that deficient products are automatically separated out without a check by a user taking place. An automatic feeding of the products from the removal and/or checking region to a separate processing process can also be provided so that products that appear unsuitable for the processing along the processing line can nevertheless be used and processed elsewhere.

In general, this adaptation of the transport path can also take place automatically or an instruction to this effect can be transmitted to a user who, for example, manually returns the products to a work station arranged upstream, guides them past a subsequent work station, or earmarks them for a rejection.

It can thus generally be provided in a generalizing manner that a subsequent step of the product processing is adapted in dependence on the parameter.

In some embodiments, the generated instruction can be adapted considering previous instructions that have already been executed. Accordingly, an instruction that is generated on the basis of a respective specific parameter can be optimized in that the results of already generated and executed instructions can be considered in this respect. For this purpose, the generation of the instruction can, for example, take place by a self-learning algorithm that, in addition to the specific parameter, also considers information on whether an adaptation of the processing process performed on the basis of an instruction has led to a desired result.

Thus, a control variable adaptation or the instruction for such a control variable adaptation can, for example, be changed if, despite the adaptation typically performed on the basis of the parameter, results that are not completely satisfactory are recognized or are detected by the determination of the parameter. This enables a particularly flexible control and a flexible operation and use of the processing line since, due to the retroactive consideration of the results of adaptations, external conditions with respect to the environment of the processing line can also be implicitly considered. The adaptation can thus not only take place individually for consecutive products, but the instruction determining this adaptation can be continuously optimized during the operation.

Provision can be made that the generated instruction is automatically executed. The processing of the products can thereby be completely automatically performed since, for example, any necessary adaptations of control variables or of the transport path can be automatically performed and the operation only has to be monitored by a user. Due to the linking of the work stations with one another, a flexible and product-specific operation can thus be achieved without the user having to have specific expertise with respect to the control of the processing line or of the individual work stations.

Due to such an automatic operation, any adaptations can furthermore take place directly without any action of the user being necessary. The product processing can therefore itself vary within a batch and can in so doing be individually and directly adapted to the respective product, which, when a setting by a user is required, is often not possible due to the rapid succession of products at the work stations.

In particular if the generated instruction is adapted before the automatic execution while considering previous instructions, an intelligent and self-optimizing control of the operation can take place. Due to such a control, preset limit values for control variables of work stations can generally also be shifted, for example on the basis of trends and/or statistics, to be able to respond automatically, flexibly, and optimally to specific operating situations or different products to be processed.

Provision can be made that the automatic operation or the automatic execution of generated instructions can be enabled by a user so that the control of the processing line in a basic setting is incumbent on the user. If applicable, provision can in this respect be made that the generated instruction, which may be adapted on the basis of previous instructions, is communicated to the user in this basic setting, for example, in that this instruction is displayed on a screen as an indication of a necessary adaptation. A user can thereby freely decide to what extent he wants assistance in the control of the processing line. A function of an adaptation or a shifting of limit values taking place during the operation can in particular also be enabled beforehand by a user.

In some embodiments, a sorting and/or alignment device by means of which the products are handled in dependence on the at least one parameter can be arranged upstream of at least one of the work stations with respect to the transport path. In general, a pre-alignment of the products can take place in such a sorting and/or alignment device to feed them optimally aligned with the work station arranged downstream. This can, for example, take place by rotating or tilting the product to set it into the correct orientation prior to the processing in the work station arranged downstream. Furthermore, a track distribution can be disposed in the handling of the products so that, for example, two tracks are loaded as uniformly as possible with respect to the weight of the products guided thereon or the products can be distributed over different tracks depending on their quality.

Provision can be made that the orientation of the products is changed by means of the sorting and/or alignment device. In this respect, the orientation in particular refers to the alignment of a product and can, for example, be corrected by rotating or tilting the product to one side.

Due to the change of the orientation, the product can thus be fed to the work station arranged downstream in the optimal alignment for the following processing step. In this respect, the orientation can generally be changed before and/or after a processing at a work station, with the parameter in each case being determined before the change made.

Such a pre-alignment can in particular be relevant when the products are compressed or shaped in the course of the processing at one of the work stations such that a desired action of the forces can be achieved by the alignment. Furthermore, the products to be processed, in particular fresh meat products, can have bones. Due to a correct alignment of such a product, a bone can, for example, be prevented from breaking or splintering during a compression or shaping. A further change in the orientation of the product can, if necessary, take place following such a processing in order to facilitate the further transport or to already align the product for the processing at a subsequent work station. This subsequent change in the orientation can in this respect take place based on the same parameter on the basis of which the alignment of the product was changed prior to the compression, while it is also possible that, after the compression or shaping, a further parameter is determined on the basis of which the further change takes place.

In general, it is also possible in this respect that such a function for changing the orientation of the products is provided, but can be switched off so that generally no change of the orientation takes place for specific products or batches. Such a switching off can, for example, take place by a user or automatically on the basis of a specific parameter.

Provision can be made that the products are distributed over a plurality of tracks by means of the sorting and/or alignment device. In this respect, the products can, for example, be distributed over a plurality of tracks of the transport path such that each of the tracks is loaded with products of approximately the same total weight. Furthermore, a sorting of the products can take place in accordance with their quality in that products of a higher quality or better processed products are transported further in a specific track, whereas products of a less high quality are distributed to another track. A sorting in accordance with the product quality can thereby already take place during the processing so that said sorting no longer has to be checked in detail after the processing. In dependence on their quality, the processed products can thus be handled further immediately or can be supplied as desired to different customers. Provision can likewise be made to distribute or to sort the products to different tracks in dependence on their volume so that the processed products can be transferred from the processing line already sorted in accordance with their volume or size for further handling.

Furthermore, the products can be distributed by means of the sorting and/or alignment device to functional paths which are arranged next to the transport path and on which the products can, for example, be returned to work stations arranged upstream, can be guided past a following work station, or can be guided into a removal and/or checking region. This also enables a flexible handling of the products in that a processing that took place in an unsatisfactory manner can be performed again, specific processing steps can be omitted, or products can be sorted out.

Such a distribution of the products over a plurality of tracks can, for example, be achieved by a lateral shifting, by vertically pivotable rockers, or by adjustable switches.

Provision can be made that the products are guided in at least one of the tracks into a removal and/or checking region. Products recognized as unsatisfactory or unsuitable for subsequent steps on the basis of the specific parameter can thus be discharged and can be checked by a user in the removal and/or checking region. The user can, if necessary, feed the products to the processing line again at a desired position or can sort out unusable products or feed them to a separate processing process. Provision can generally also be made that the removal and/or checking region is used directly as a reject zone without a check by a user taking place. This can in particular be provided in the case of an optimized and automatic control that reliably recognizes products to be sorted out and nevertheless minimizes the product waste in so doing.

Furthermore, provision can be made that the products are automatically fed from the removal and/or checking region to a further process so that these products are processed elsewhere than on the processing line. Products that are unsuitable for a processing along the processing line can thus nevertheless be used and processed in an adapted manner in a separate process.

In some embodiments, the products can be guided in at least one of the tracks past at least one of the subsequent work stations. For example, such a guiding past can make it possible to process products of different types at the same time and in an adapted manner in each case. Thus, products of one type can in this respect remain on the transport path and can be guided through all the work stations, wherein the processing is performed individually adapted to these products and, if necessary, to each product. Products of the other type can, however, be guided in a track past a work station if a specific processing step is not intended or necessary for them. These products can thus be guided past the respective work station without the processing of the products of the other type processed therein being disturbed. If necessary, on a guiding of products past a work station, the track that is then in principle free at this work station can also be used for products to be processed in order thereby to increase the product throughput.

Furthermore, the products guided past a subsequent work station can generally also be guided into a removal and/or checking region.

In some embodiments, the products can be returned in at least one of the tracks to a work station arranged upstream of the sorting and/or alignment device or to a functional unit arranged upstream of the processing line. Due to such a return to a work station arranged upstream, an unsatisfactory processing can be corrected, for example. If necessary, the return can in this respect also take place a multiple of times if, despite the processing that took place again, it is determined on the basis of the parameter that no satisfactory result could be achieved again. Furthermore, the parameter on the basis of which the return of the product to a work station arranged upstream is initiated can additionally require an adaptation of a control variable of this work station to achieve an improved processing.

In some embodiments, at least one functional unit arranged upstream of the processing line can be provided and/or at least one functional unit arranged downstream of the processing line can be provided, wherein a control variable of the respective functional unit is adapted in dependence on the at least one parameter, and/or wherein at least one further parameter is determined at the respective functional unit and is considered at least one position of the processing line.

Such functional units arranged upstream or downstream of the processing line can, for example, be a product store and a packaging machine to which products are transferred after the processing, if necessary, automatically. These functional units can in this respect be adapted in dependence on a parameter determined at a work station in that, for example, the cooling temperature of a product store is changed if such a change seems expedient on the basis of the determined parameter. A further parameter, which is considered in the control of the processing line, can likewise be determined at the functional units. A communication thus takes place beyond the processing line in that functional units arranged upstream or downstream are also included in the linking and their state is considered. The operation can be further optimized by this additional information.

Information on the batch status, such as the expected end of the processing of a total batch or the time required to process a batch, can in particular be determined by the functional units arranged upstream and downstream. The end of the operation or of the processing of a batch can thus be predefined by a specific number of processed and packaged products, wherein the status of the processing can be determined by the number of packages already filled or the number of completely processed products transferred to a packaging machine arranged downstream.

Provision can be made that, in a last step, the products are cut into slices at the processing line and portions are formed from said slices and are transferred to a packaging machine. In this respect, a communication of the packaging machine with the processing line can, for example, take place such that the slice thickness within a tolerance range is adapted on the basis of the number of already packaged portions that can be determined at the packaging machine. Thus, a desired number of portions can, if necessary, still be achieved with the products already located within the processing line and the product feed from the product store arranged upstream can be interrupted. Due to such an inclusion of the packaging machine, it can in particular be prevented that large product residues remain in the processing line after a reaching of the desired number of packaged portions and possibly have to be separated out. Due to the consumption of the products that is as complete as possible in the processing line, possible modifications for subsequent batches or the cleaning of the processing line can also be facilitated and accelerated.

Furthermore, based on the parameter determined at a work station or the detected batch status, the stocks can also be checked or modifications or sorting can be performed in a product store for subsequent batches. A pending restocking of the store or a pending change of a material roll of a packaging machine can also, if necessary, be considered at the work stations or during the transport, for example, by slowing down the transport for a short time to enable such a change in a nevertheless continuous operation.

Provision can be made that the at least one further parameter determined at a respective functional unit is considered at a position of the processing line in the same manner as the at least one parameter determined at the work station. Accordingly, based on the further parameter, a signal perceptible to a user can likewise be generated, in particular also a warning signal, and direct instructions or indications can be transmitted to a user. Equally, automatically executed control signals can generally also be generated in dependence on the further parameter. An adaptation of the transport path or a change of the orientation of the products can also take place on the basis of a consideration of a further parameter determined at a functional unit arranged upstream and/or downstream. It is likewise possible to consider one or more further parameters determined at a functional unit arranged upstream and/or downstream at one position of the processing line together with parameters that were determined at other positions of the processing line. Possible changes of the processing process can thus also be made on the basis of combinations of different parameters or parameters determined at different positions.

In some embodiments, a product store can be provided which is arranged upstream of the processing line with respect to the transport path and in which the products are stored, wherein a control variable of the product store, in particular a cooling temperature, is adapted while considering the at least one parameter, and/or wherein at least one further parameter, in particular a cooling temperature, is determined at the product store and is considered at a position of the processing line. For example, the cooling temperature of a product store can be adapted if the determined parameter suggests the need for a stronger cooling of the products. This can, for example, take place when the products are cut during the processing at one of the work stations and large fluctuations of the cutting forces are registered that may result in an undesired variation in the cutting quality.

Furthermore, the cooling temperature of the product store can also be considered at the processing line in that the processing steps are adapted in dependence on this cooling temperature. Provision can in particular be made that an intermediate cooling of the products takes place during the processing, wherein the dwell time of the products in this intermediate cooling can be set while considering the cooling temperature in the product store.

In some embodiments, a packaging machine arranged downstream of the processing line with respect to the transport path, in particular a deep-draw packaging machine, can be provided by means of which the processed products are packaged, wherein at least one control variable of the packaging machine is adapted in dependence on the at least one parameter, and/or wherein at least one further parameter is determined at the packaging machine and is considered at least one position of the processing line.

The processed products can thus be transferred directly to a packaging machine, wherein the products can be placed directly in or on packaging spaces provided, for example, depressions drawn into a film or trays provided. Provision can also be made that the products are transported to and transferred to the packaging to machine by means of further transport devices, in particular so-called feeders.

For example, the dimension or size of the packaging spaces can be determined at the packaging machine and can be transmitted to one of the work stations that acts on the size of the products or shapes them during the processing. In this respect, a control variable of this work station can be set such that the products are sufficiently compressed to enable a packaging of the completely processed products in the packaging spaces provided. In this respect, provision can in particular be made that the products are cut into slices in a final step of the processing, wherein portions of these slices are transferred to the packaging machine. Due to a compression of the products before the cutting, the slice size can thus be influenced so that it can be ensured that the portions created can be packaged. Furthermore, a targeted shaping of the products to be sliced can also take place at such a work station, for example, in order to give subsequently produced slices a desired contour or to adapt them specifically to the shape of the respective packaging.

Conversely, the size of the products can, for example, be determined at one of the work stations of the processing line and transmitted to the packaging machine that can accordingly flexibly adapt the dimension of the depressions or the selection of the trays to the size of the processed products to be expected. This may even make it possible to individually adapt the size of the packaging to a specific product within a batch to be able to save packaging material, for example. Furthermore, evacuation and/or gassing processes during a drawing of depressions in a film web can also be adapted to the portion size or to the filling volume of a package to be expected.

In some embodiments, a marking device can be provided in which the products are marked, wherein the processing line can comprise an identification device in which the marked products are detected.

Such a marking device can in particular be arranged upstream of the processing line so that products can, if necessary, also arrive already marked in a product store arranged upstream of the processing line. In this marking device, barcodes can, for example, be applied to the products or a chip can be inserted so that a subsequent and unique identification of the product in an identification device is possible. A large amount of information on the respective product can thereby be automatically and immediately provided and the processing can be specifically directed towards this product. This information can, for example, relate to specific product features such as the type, the weight, the product dimensions, or the structuring of the product.

For this purpose, the identification device can be provided as a separate device and in particular at the start of the transport path so that the information available through the identification of the product can be used during the total processing and each of the processing steps can be performed while considering this information. It is likewise possible that the identification device is integrated as a unit into one or more of the work stations or into another device arranged at the processing line.

Provision can be made that at least one control variable of at least one work station is adapted in dependence on the detected product. Due to the identification of the product, the work station can thus be set and adapted specifically to the detected product, wherein the information about the properties of the respective product available due to the identification is used. Provision can in particular also be made that control variables of a plurality of or even all of the work stations are simultaneously adapted in dependence on the detected product, for example, in order to bring the work stations to the basic settings for a specific product type.

In some embodiments, an examination device by means of which at least one product feature is determined can be arranged upstream of at least one work station with respect to the transport path. This product feature can so-to-say be understood as a product-related parameter and can, for example, relate to the weight, the size, the quality, the position or orientation, the temperature, the fat or meat content of a product, or its surface property.

Provision can be made that the product feature is considered in the processing of the products at least one work station arranged downstream of the examination device. Accordingly, a device that specifically serves to determine product features can also be provided separately from a work station, wherein said product features can also be considered in the processing of the products. By considering the product feature in a work station arranged downstream, said work station can be optimally set to the product to be processed.

Provision can furthermore be made that the product feature is considered in the processing of the products at at least one work station arranged upstream of the examination device. The product feature can thus be considered retroactively and can in particular serve to check and report back the result of a processing by a work station. Due to such a check of the results of the processing, a possibly performed adaptation of control variables of the respective work station can also be changed and optimized on the basis of a specific parameter by making both the specific parameter and the subsequently determined product feature available to a self-learning algorithm for controlling the processing line. A continuously optimizing operation of the processing line can thereby be made possible.

Provision can be made that the at least one product feature is considered at another position of the processing line in the same manner as the at least one parameter determined at the work station and/or that the at least one product feature is considered at another position of the processing line in the same manner as a further parameter determined at a functional unit arranged upstream or downstream of the processing line.

Thus, a signal perceptible to a user can generally also be generated on the basis of the product feature and can, for example, be an acoustically or visually perceivable warning or alarm signal or an instruction displayed on a screen, wherein automatically implemented instructions for adaptations of control variables of work stations can also be generated on the basis of the product feature. An adaptation of the transport path can likewise take place based on the product feature so that specific products can, for example, be guided past a subsequent work station, returned to a work station arranged upstream, or guided into a removal and/or checking region, wherein this instruction can also be both transmitted to a user and executed automatically.

Furthermore, based on the product feature, the processing can also be suspended at least one of the work stations if a specific processing step is not required for this product or, if applicable, a series of consecutive products.

In some embodiments, one of the work stations of the processing line can be a cooling device at which the products are cooled at a predefined or predefinable cooling temperature or at which the products are cooled to a predefined or predefinable temperature. Such a cooling device can generally comprise a pre-cooling and/or an intermediate cooling, wherein the cooling device generally serves for the temperature control of the products in order to prepare them for a subsequent processing step or the subsequent processing steps. In this respect, the cooling temperature of the cooling device and the dwell time of the products at this device can be defined or can be in the process of being defined, while it is also possible to cool the products at the cooling device until they have a desired temperature so that the cooling can take place while considering the respective product temperature and can be adapted thereto. A plurality of cooling devices can also be provided that can be arranged upstream or downstream of further work stations, while the further work stations can generally also comprise means for cooling the products.

Provision can be made that the cooling temperature and/or the dwell time is/are determined as a parameter at the cooling device. Due to this determination, the cooling temperature and/or the dwell time can thus be considered at another position of the processing line. In this respect, the dwell time in particular indicates the duration during which the products are in the cooling device and a cooling takes place. In the case of a constant movement of the products along the transport path, said transport path can be predefined by the transport speed and can thus correspond to the throughput time of the products through the cooling device. However, it is also possible to stop the products in the cooling device to achieve a cooling as desired.

Provision can be made that the cooling temperature and/or the dwell time is/are adapted in dependence on at least one parameter determined at another work station. For example, the dwell time of the products at the cooling device can be increased if, based on the parameter determined at another work station, it is determined that the products do not reach this work station sufficiently cooled. If, for example, a work station is provided at which the products are cut into slices, the cutting forces occurring during the cutting can be used for a check of a sufficient cooling.

In some embodiments, one of the work stations of the processing line can be a pressing and/or shaping device at which the products are compressed and/or shaped. At such a work station, the products can in particular also be shaped, wherein the dimensions of the product are changed in a targeted manner. At such a station, irregularities in the shape of the product can be evened out so that the completely processed products have a uniform size and quality and as uniform a weight as possible.

Provision can be made that the temperature of the products and/or forces occurring during the pressing, in particular pressing and/or return forces, and/or return paths are determined as parameters at the pressing and/or shaping device. In this respect, the temperature can be measured before, during, and/or after the pressing and the respective measurement values can be considered at another position in the processing line. It is generally also possible to provide only some of these measurement points or to determine and consider some of these measurement variables. The pressing forces can in particular, for example, be used to adapt a cooling temperature of a cooling device arranged upstream of the pressing device if, for example, undesirably large pressing forces are necessary to achieve a desired compression.

Furthermore, the volume of the products can be determined at the pressing and/or shaping station. For this purpose, the positions of elements that compress and/or shape the products can in particular be checked and the product volume can be determined from their positions. Alternatively or additionally, forces acting at these elements, such as pressing or return forces, can also be used to determine the volume.

Provision can be made that a control variable of the pressing and/or shaping device is adapted in dependence on a parameter determined at another work station. For example, the presence or the position of a bone in a fresh meat product can be determined at a work station arranged upstream of the pressing and/or shaping device so that the pressing forces or their direction in the pressing and/or shaping device can be set adapted thereto to avoid a breaking or splintering of the bone.

In some embodiments, one of the work stations can be a cutting apparatus, in particular an automatic slicer, at which the products are cut into slices. The slice thickness can in this respect be variably settable so that thicker pieces, for example thicker pieces of a fresh meat product, are also designated as slices. Provision can likewise be made that the products are cut or chopped into regular or irregular pieces by means of the cutting apparatus. This alternative possibility can generally also always be provided when a cutting and in particular a cutting into slices is described in the following and the alternative possibility is not explicitly mentioned.

Subsequently, portions that comprise at least one slice can be formed from these cut slices. The product processing along the processing line can in particular be completed with such a formation of portions and the portions can be transferred to a functional unit arranged downstream, in particular a packaging machine.

Provision can be made that the temperature of the products and/or the degree of freezing of the products so and/or the cutting forces are determined as parameters in the cutting apparatus. In this respect, the determination of the temperature and/or of the degree of freezing can take place in a feed region of the cutting apparatus, in a direct region of the cutting apparatus directly in front of or behind the blade cutting the products into slices, and in a portioning region provided behind the blade with respect to the transport path, wherein all of these measurement points or only some of them can be provided. Accordingly, it is possible to measure the temperature and the degree of freezing at the cut surface before the cutting, at falling slices as well as at the cut-off slice, directly after the cutting, or in the further course of the handling.

These parameters can thus also be considered at the other work stations of the processing line. In particular the cooling temperature of a cooling device or of a pressing and/or shaping device that likewise cools the products can, for example, be adapted on the basis of the cutting forces determined.

Provision can be made that at least one control variable of the cutting apparatus is adapted in dependence on a parameter determined at another work station. For example, the surface property or the temperature development along a product can be determined in a pressing and/or shaping device, wherein the slicing process and in particular the cutting forces or the cutting angle can be adapted in dependence on these parameters.

In accordance with a further aspect of the invention, the invention relates to a system for processing food products to be sliced and/or to be divided, in particular for processing fresh meat and/or bacon, comprising a processing line, preferably for performing a method as disclosed herein, that comprises a plurality of work stations and a single-track or multi-track transport device for transporting the products along a transport path from work station to work station. In this respect, at least one of the work stations has a means for determining at least one parameter, wherein the means is connected to an evaluation and control device that is configured to generate a control signal in dependence on the at least one parameter.

The determined parameter is thus transmitted to the evaluation and control device that evaluates it and generates a control signal in dependence thereon. The generated control signal can generally also depend on a plurality of parameters and can thus be adapted while considering a plurality of parameters or pieces of information. This signal can be transmitted to a further device so that, for example, an alarm can be triggered to alert a user to a malfunction or an incorrect setting of a part of the processing line. Depending on the device receiving the signal, an instruction or a visually perceptible indication can also be generated so that a user can be informed of a necessary adaptation of one of the work stations. If necessary, the control signal can also be transmitted directly to one or more work stations and an automatic adaptation of its setting/their settings can take place.

The control signal can thus be directly or indirectly, through notification or activation of a user, be included in the processing of the products and cause an adaptation. The operation of the processing line can thereby be considerably simplified and made more flexible since the generated control signal offers possibilities of achieving an optimal operation also in the event of an operation by a user without many years of experience in the control and setting of the work stations.

The determined parameter can in this respect both be product-related and relate to a feature of the product and to a value of a control variable of the respective work station.

Thermal imaging cameras, scanners, scales, laser thermometers, a camera for surface analysis, image recognition programs, or X-ray devices, by means of which in particular the position of a bone in a fresh meat product can be detected, can be provided as means for determining the parameter, for example. Furthermore, force development measurements can take place during the processing, whereby breaking or splintering bones can, for example, be recognized in a device in which the products are compressed or shaped during the processing.

In some embodiments, the evaluation and control device can be connected to a warning device that is configured to generate a warning message in dependence on the control signal. This warning message can, for example, be visually or acoustically perceptible by a user and can in principle be provided as a mere warning signal in the form of a sound, a sound sequence, or one or more illuminating lamps. If applicable, such a warning signal can also be triggered directly at a respective work station so that a user is made aware of the work station that is to be adapted.

In general, specific action instructions, for example for a setting of one of the work stations, can also already result from the warning message.

Provision can be made that the evaluation and control device is connected to a display device, wherein the display device is configured to display, in dependence on the control signal, an instruction for adapting at least one control variable of at least one work station.

This instruction can in this respect relate to both the work station at which the parameter is determined and a work station arranged upstream or downstream thereof. The displayed instruction can be a direct indication of a specifically to be performed adaptation of a control variable of one of the work stations in the form of a setting value. In general, however, only warning messages or indications that one of the work stations may be faulty or not working optimally and should be checked by a user can be displayed.

Provision can also be made that settings for all the work stations are suggested on the basis of the generated control signal that is generated in dependence on the parameter. Such overall settings of the processing line can, for example, be stored as predefined programs in the evaluation and control device which a user can select before the start of operation or before the start of a processing of a batch. Accordingly, the optimal program can be suggested after a detection of the first product of a batch and the determination of parameters so that no experience of the user is required for such a setting either.

Furthermore, such an instruction can also specify a suspension of the processing of the products at one of the work stations such that a mere guiding of the products through this work station takes place without processing. The processing line can thereby be flexibly adapted to the products to be processed, wherein only the necessary processing steps are performed in the case of an optimal setting of the respective work stations.

An input device connected to at least one of the work stations, in particular to all the work stations, can be provided by means of which the settings of the at least one work station, and in particular the settings of all the work stations, can be changed. This input device can in particular be integrated into a display device that is configured to display an instruction for adapting control variables of the work stations in dependence on the control signal. Due to such an input device, which can also be connected to or correspond to the evaluation and control device, a user can consequently control the processing line or at least individual work stations. Since this input device can in particular be integrated into a display device, for example in the form of a touch screen, the user can directly execute indications/instructions displayed at the display device for adapting settings of the work stations in a particularly simple manner and the processing line can be both monitored and controlled in one location.

The evaluation and control device can be connected to at least one other work station, wherein the evaluation and control device can be configured to automatically adapt at least one control variable of the at least one other work station by transmitting the control signal. This can enable a fully automatic operation of the processing line, wherein said operation is always adapted to the respective operating situation during the processing on the basis of the determined parameter. Due to the control signal, both a control variable of a work station arranged upstream and a control variable of a work station arranged downstream can be adapted in this respect. On a control of a work station arranged upstream, it can be achieved that the products arrive optimally pre-processed at the work station at which the respective parameter is determined and retroactive corrections can be made. Due to a transmission of the control signal to a work station arranged downstream, the latter can already be specially set to the following product and even a product-specific processing can be made possible.

Provision can be made that the evaluation and control device comprises a processor that is configured to execute a self-learning algorithm. Due to such a self-learning algorithm, the control and the operation of the processing line can be continuously optimized in that the control signals output by the evaluation and control device are adapted while considering control variable adaptations that were made in the past. In this respect, statistics or possibly registered trends with respect to the results of previous control variable adaptations can in particular be considered in a subsequent adaptation. In this respect, provision can generally also be made that preset limit values for specific setting values of a work station can be adapted when an exceeding of this limit value, for example, appears necessary based on a registered trend.

Provision can be made that both the automatic operation and the generation of signals are enabled by a user by means of a self-learning algorithm. In a basic setting, no automatic operation of the processing line therefore takes place and a user can perform the control and setting of the work stations in any desired manner. The enabling to adapt preset limit values where necessary may in particular also have to be explicitly granted by a user.

The processing line can comprise at least one examination device for determining at least one product feature, wherein the examination device is connected to the evaluation and control device, wherein the evaluation and control device can be configured to generate a further control signal in dependence on the at least one product feature. This control signal can be treated in the same manner as a control signal triggered at a work station on the basis of a parameter determination. Accordingly, depending on the processing of the control signal and the connection of the evaluation and control device, said control signal can also be used for the control of a warning device or of a display device or for an automatic control of work stations.

A determined product feature can, for example, be, the weight, the size, the quality, the position or orientation, or the temperature of a product. Furthermore, the temperature development along a product, its fat or meat content, or the surface property and structure of a product can be determined. For this purpose, the examination device can, for example, comprise a thermal imaging camera, a laser thermometer, a camera, and an image processing device for analyzing the surface structure, a scale, a scanner, or an X-ray device.

Provision can be made that the processing line comprises a sorting and/or alignment device that is connected to the evaluation and control device, wherein the sorting and/or alignment device is configured to change the orientation of the products and/or to distribute the products over different tracks in dependence on the control signal.

In this respect, the orientation of the products in particular refers to their alignment that can, for example, be changed by rotating or tilting the product to one side. This can in particular be used to bring products into an alignment that is optimal for this processing or this work station before the processing at one of the work stations, wherein this optimal alignment can be determined on the basis of the parameter and a corresponding control signal can be generated.

Furthermore, the products can, for example, be distributed over different tracks of the transport path in dependence on the parameter to achieve an approximately equal total weight on the different tracks. The products can likewise be sorted in the individual tracks in accordance with their quality so that the processed products leave the processing line already sorted in accordance with their quality and can thereby facilitate a further handling or a supply as desired to customers of the processed products.

Alternatively or additionally, provision can be made that tracks are provided which are arranged next to the transport path and in which the products can, for example, be returned to a work station arranged upstream in order to correct an insufficient processing and to achieve a desired result. Tracks can also be provided in which the products are guided into a removal and/or checking region or are guided past at least one of the work stations. For a product placed onto such a track, no processing consequently takes place at the respective work station, while the processing is not generally suspended so that subsequent products continue to be processed there.

In some embodiments, the processing line can comprise at least one functional path which branches off from the transport path, on which the products can be returned to a position of the transport path arranged upstream, and/or on which the products can be guided into a removal and/or checking region, and/or on which the products can be returned to a functional unit arranged upstream of the processing line. Such a transfer of the products onto the functional path can, for example, take place by a sorting and/or alignment device, wherein the work stations can also have means to convey products from a transport path onto the functional path. For example, provision can be made that the products are compressed and/or shaped at one of the work stations, wherein such a work station can comprise an element for compressing the products which extends in the longitudinal direction along the transport path and by means of which the products can also be conveyed from the transport path onto a functional path by a further advancement.

Thus, unsatisfactorily processed products can, for example, be returned on the functional path to a work station arranged upstream and can be processed again there to enable a processing as desired. In this respect, such a return can also take place a multiple times if the desired result has not been achieved despite the reprocessing.

In a removal and/or checking region, the products guided there can be checked by a user and, if necessary, can be fed to the processing line again or separated out. It is generally also possible that no check by a user takes place in the removal and/or checking region, but that this region functions as a direct reject zone or that the products are directly and automatically fed from the removal and/or checking region to a further process. Due to the feeding of the products to a further process, products that appear unsuitable for the processing along the processing line can, if necessary, also be used and processed further accordingly.

In this respect, the mentioned return of the products to a work station arranged upstream does not necessarily mean that the products have already been processed at this work station. Rather, it is also possible that a work step that was not carried out initially and is subsequently recognized as necessary is made up for by returning the products to the respective work station. This necessity can in particular be recognized on the basis of the determined parameter.

In some embodiments, at least one functional unit arranged upstream of the processing line can be provided that is connected to the evaluation and control device and/or at least one functional unit arranged downstream of the processing line can be provided that is connected to the evaluation and control device. In this respect, the evaluation and control device can be configured to automatically adapt at least one control variable of the functional unit by transmitting the control signal to the respective functional unit and/or the respective functional unit can have a further means for determining at least one further parameter, wherein the further means is connected to the evaluation and control device, and wherein the evaluation and control device is configured to generate a corresponding control signal in dependence on the further parameter.

This corresponding control signal can also be handled in the same manner as the control signal generated on the basis of a parameter determination at a work station or on the basis of a product examination. Accordingly, this control signal, which is generated on the basis of a parameter determined at a functional unit arranged upstream or downstream of the processing line, can generally also serve for a user communication in that, for example, a warning message is generated by means of a warning device or an instruction is generated on a display device. Furthermore, this control signal can in principle also be used for an automatic control of the work stations or for a sorting of the products.

Such a connection of the evaluation and control device to a functional unit arranged upstream and/or downstream of the processing line can consequently enable a communication and linking of the operation beyond the processing line. This allows as large as possible an amount of information to be considered in the control of the operation and thus the operation to be optimized.

In some embodiments, one of the work stations of the processing line can be a cooling device for cooling the products. In such a device, a temperature control of the products generally takes place, wherein a pre-cooling, a post-cooling, or an inter-cooling can be performed. Such a cooling can, for example, compensate an insufficient cooling of the products in a product store that can occur when a product is stored at the margin of the product store or the cooling is disturbed based on a restocking of the product store. It can consequently be ensured by such a cooling device that the products reach the further work stations at the correct or desired temperature.

In some embodiments, one of the work stations of the processing line can be a pressing and/or shaping device that comprises at least one movable contact element, in particular at least one punch, by means of which the products can be compressed and/or shaped. For this purpose, the contact element can in particular cooperate with a counter-element to compress and to shape the products by a pressing against this counter-element that can, for example, be configured as a wall or as an element that can be moved oppositely to the contact element.

Due to such a compression, the size and shape of the product can be changed and said product can be adapted to the following processing steps or to a desired size of the processed products. If the products are cut into slices in a subsequent step, for example by means of a cutting apparatus, the surface size of these slices can already be predefined by the pressing and/or shaping device. Furthermore, provision can also be made to specifically change the shape of the products by means of the pressing and/or shaping device and to adapt said size as desired.

The pressing and/or shaping device can in particular also be configured to produce desired, predefined, or predefinable shapes of the products.

The movable contact element can in this respect extend in the longitudinal direction along the transport path or transversely thereto. To compress the products or to bring them into an intended shape, the contact element can press them against an oppositely disposed counter-element that can, for example, be provided as a wall. However, this counter-element can also be movable as well and can accordingly be provided as a contact element movable in the opposite direction.

The pressing and/or shaping device can in particular have at least one contact element extending longitudinally with respect to the transport path and at least one contact element extending transversely with respect to the transport path so that a product can be compressed in both directions or the shape of the product can influenced from both directions.

The pressing and/or shaping device can comprise a servomotor by which the at least one contact element can be driven. This allows a precise setting of the contact element so that the pressing or shaping can take place in a particularly precise and product-specific manner while considering the respective product properties.

The pressing and/or shaping device can have at least one counter-element with which the at least one contact element cooperates to compress and/or to shape the product, wherein the counter-element and/or the contact element can be at least partly variable in shape.

In this respect, the counter-element can, for example, be configured as a wall against which the product is pressed by means of the contact element, while it is also possible to provide the counter-element in a movable manner as well such that said counter-element can also function as a contact element.

Since the counter-element and/or the contact element can be at least partly variable in shape, the respective element can adapt to a contour of the product. In particular in the case of a fresh meat product that has a bone, the position and shape of the bone can be considered by the shape-variable design to prevent a breaking or splintering of this bone during the compression of the product. For this purpose, the respective element can adapt to the contour of the bone during the compression and can contact it or reproduce its shape.

Furthermore, the formation of the pressing and/or shaping station with such a shape-variable element can make it possible to specifically influence the shape of the products during the compression and to form desired contours at them. Not only rectilinear contours, but generally any desired contours or shapes of the products can in particular be produced in this manner in that the products are compressed by a movement of the contact element with respect to the counter-element and the respective element of variable shape is used for shaping.

To enable an adaptation to the contour of a product by a change in shape, the respective element can, for example, be produced from an elastic material or can have a cushion that is filled with gel or a gas, in particular air, and that can be deformed by a pressure occurring during the compression. Furthermore, provision can be made that only part surfaces of the respective element are elastic, wherein these part surfaces can also be distributed over a plurality of elements arranged next to one another, for example, a plurality of punches.

Such a pressing and/or shaping device having a contact element and/or counter-element of variable shape can thus enable a particularly product-specific processing, wherein specific contours or properties of the respective products can be considered.

In this respect, the present invention also relates, independently of the explained system for processing products comprising a processing line, to a pressing and/or shaping device for compressing and/or shaping products that has at least one movable contact element and at least one counter-element cooperating therewith in order to compress and/or to shape a product, wherein the counter-element and/or the contact element is/are at least partly variable in shape.

Provision can be made that the counter-element and/or the contact element is/are variable in shape in response to a control signal of the evaluation and control device. The change of the shape of the respective element can thus be actively controlled, for example, when the position and contour of a bone are recognized on the basis of a parameter determined at a work station or on the basis of a product feature. Accordingly, the shape of the respective element can already be adapted to this contour so that the element reproduces the structure of the bone and a possible breaking or splintering of the bone during the compression can be prevented.

Alternatively or additionally, the desired shape or contour of the product after the compression can be actively influenced by such a directly controllable element of variable shape so that, for example, slices shaped as desired can be cut from the product in a subsequent step. Such an adaptation can also take place in dependence on a parameter determined at one of the work stations or at another functional unit. For example, provision can be made that the shape of the packaging spaces provided for the completely processed products, for example depressions or trays drawn in in a film web, is determined at a packaging machine arranged downstream of the processing line and the shape or contour of the products in the pressing and/or shaping station is adapted to the respective packaging spaces by controlling the element of variable shape.

Provision can also be made that the counter-element and/or the contact element is/are variable in shape due to pressure. Accordingly, a passive shape change can also take place so that the respective element automatically adapts to a specific shape or contour of the product during the pressing.

In some embodiments, a cutting apparatus for slicing the products into slices, in particular an automatic slicer, can be integrated into the pressing and/or shaping device. This enables a particularly compact design, wherein the products can be fed directly into the cutting apparatus. The thickness of the slices can in this respect vary in dependence on the respective product processed so that thicker pieces, which can, for example, be produced on a processing of fresh meat, are also to be understood as slices. The slicing of the products can in particular represent a final step of the processing along the processing line, wherein portions are formed from the slices that comprise at least one slice and that can subsequently, if necessary, be further handled at a functional unit arranged downstream.

This pressing and/or shaping device consequently allows a particularly compact design in that two work stations, which per se are to be provided separately, are directly connected to one another and integrated into one another. In this respect, the present invention also relates, independently of the explained system for processing products comprising a processing line, to a pressing and/or shaping device for compressing and/or shaping products into which a cutting apparatus for slicing the products into slices, in particular an automatic slicer, is integrated.

Provision can be made that the pressing and/or shaping device has a feed means that is configured to feed the products into a cutting plane of the cutting apparatus in which the products are cut into slices by means of a blade, in particular a rotating circular blade or scythe-like blade.

A contact element or a punch of the pressing and/or shaping device can in particular be provided for this purpose. This contact element can in this respect advantageously satisfy a dual function by serving both for the compression of a product and for its feed into the cutting plane. Accordingly, the cutting apparatus can be arranged directly downstream of the press so that a particularly compact design can be achieved.

Provision can be made that a gripper for holding the product is integrated into the feed means. This gripper can, for example, be formed with barbs or claws so that it can already be automatically introduced into the product during the pressing. Furthermore, it is possible for the gripper to be displaceable or movable so that the product is first compressed and/or shaped and the gripper can only subsequently be brought into an active position in which the product is gripped by it and held during the feed.

The pressing and/or shaping device can have a means for cutting the products to size prior to the compression and/or shaping. Due to these means, the size of the products can in particular already be adapted prior to the compression or shaping if they cannot be brought into a sufficiently reduced shape by the maximum forces that can be achieved during the compression. For this purpose, further means can be provided that hold the products in a fixed position during the cutting to size that can, for example, take place by a trimming.

The products can in particular first be held at a front-side and/or rear-side end with respect to the transport path and can be laterally trimmed or cut to size, whereupon, in a subsequent step, the products are held along the transport path and are trimmed or cut to size at the front side or rear side. Thus, the size of the products can be adapted at all the sides, wherein the order of the cuts is generally arbitrary. Provision can likewise be made to remove any product margins that are subject to quality defects and that were recognized based on one or more parameters or product features by a cutting to size or trimming of the products prior to the compression or shaping.

Provision can be made that the pressing and/or shaping device has an ejection means by means of which the products can be pushed from the transport path. This pushing out can, for example, take place by means of a contact element or longitudinal punch that extends along the transport direction and that can also serve for the compression of the products. Accordingly, said longitudinal punch can also advantageously satisfy a further function in addition to the compression. It can thereby be achieved that despite the compact design with a cutting apparatus integrated into the pressing and/or shaping device, any necessary product rejection can take place without further steps or devices.

The general idea emerges from the above statements to use at least one movable contact element of a pressing and/or shaping device in a further function in addition to the compression and shaping of products, for example for a feeding of the products into a cutting apparatus or for a lateral ejection of the products from the transport path. Due to this general idea, the possibilities of using a pressing and/or shaping device can be considerably extended while minimizing the installation space required and a particularly flexible use of such a device can be achieved.

In this respect, the present invention also relates, independently of the explained system for processing products comprising a processing line, to a pressing and/or shaping device for compressing and/or shaping products that comprises at least one movable contact element, in particular at least one punch, wherein the contact element can be moved into a compression position to compress the products, and wherein the at least one contact element is movable beyond the compression position.

One of the work stations of the processing line can be a cutting apparatus, in particular an automatic slicer, for cutting the products into slices and/or for dividing the products. Such a cutting apparatus can comprise a feed so for the products by means of which the products to be sliced and/or to be divided are fed into a cutting plane. Furthermore, the thickness of the slices cut can be influenced by the feed or its speed so that, for example, thicker pieces, in particular on the processing of fresh meat, can also be cut or produced by such an apparatus and are accordingly to be understood as slices. In a cutting apparatus operated on a multiple tracks, the feed of each track can in particular be individually controllable so that slices of different thicknesses can be cut as desired in different tracks.

To slice the products, the cutting apparatus can comprise a blade that can, for example, be configured as a circular blade or a scythe-like blade and that can rotate during the operation. Furthermore, provision can be made that the blade is guided in a planetary revolving motion in the cutting apparatus, in particular for slicing products fed on multiple tracks. Alternatively, the blade can perform a translatory movement and can, for example, produce the slices through a downwardly extending movement in a vertical plane.

The cutting apparatus can comprise a portioning belt on which portions are formed from the cut slices that each comprise at least one slice. The formation of the portions on the portioning belt can in particular represent a final step of the processing of the products along the processing line, wherein the formed portions can be transferred from the portioning belt to a functional unit arranged downstream of the processing line. For example, a so-called feeder can be provided as the first functional unit arranged downstream, said feeder transporting the portions further and, if necessary, transferring them to a packaging machine. In this respect, further transport sections can in particular also be provided between the portioning belt and the packaging machine and can, for example, serve to buffer portions or to form formats.

A packaging machine for packaging the processed products can be arranged downstream of the processing line. Accordingly, this packaging machine does not have to be fixedly connected to the processing line or provided as a fixed component thereof so that the processing line can be flexibly used. A user can in particular connect a specific desired packaging machine, in particular a deep-draw packaging machine for forming depressions in a packaging film or a tray-advancing packaging machine, to the processing line as desired and in a flexible manner. Due to the connection of a packaging machine, a complete preparation of the products can furthermore take place so that they can be delivered directly afterwards.

In this respect, the products can be transferred directly to the packaging machine and can be placed in or on provided packaging spaces, for example, depressions or trays. It is likewise possible that the processed products and in particular portions of cut slices are first transported further via further transport devices, which are likewise arranged downstream of the processing line, in particular so-called feeders, and are transferred from these devices to the packaging machine.

A product store can be arranged upstream of the processing line. The products can in particular be cooled in the product store, wherein a sorting of the products and thus a definition of the order of the processing can also take place in the product store. In particular for a sorting of the products, provision can also be made that the evaluation and control device transmits a control signal to this effect to the product store so that a processing plan can be predefined by this evaluation and control device and an adapted sorting of the products and their provision in the product store can automatically take place.

Furthermore, the transport device by means of which the products are transported along the transport path can be configured to automatically convey the products from the product store to the processing line or to automatically take over the products from the product store. For this purpose, the transport device can, for example, also have a robot by means of which the products can be placed onto the processing line or products to be placed can be selected from the product store.

In summary, the invention relates to the following embodiments of a method for processing food products:

1. A method for processing food products to be sliced and/or to be divided, in particular for processing fresh meat and/or bacon,
in a processing line comprising a plurality of work stations,
wherein the products are transported along a transport path on one track or multiple tracks from work station to work station, and
wherein at least one parameter is determined at least one work station and is considered at another position of the processing line.

2. A method in accordance with embodiment 1,
wherein the parameter relates to a feature of the product.

3. A method in accordance with embodiment 1 or embodiment 2,
wherein the parameter relates to a control variable of the one work station.

4. A method in accordance with any one of the preceding embodiments,
wherein a signal perceptible to a user is generated in dependence on the parameter.

5. A method in accordance with any one of the preceding embodiments,
wherein the parameter determined at the one work station is considered in the processing of the products at least one other work station.

6. A method in accordance with any one of the preceding embodiments,
wherein an instruction for adapting at least one control variable of at least one other work station is generated in dependence on the parameter.

7. A method in accordance with any one of the preceding embodiments,
wherein an instruction for suspending the processing at another work station is generated in dependence on the parameter.

8. A method in accordance with any one of the preceding embodiments,
wherein an instruction for adapting the transport path is generated in dependence on the parameter.

9. A method in accordance with any one of the embodiments 6 to 8,
wherein the generated instruction is adapted considering previous instructions that have already been executed.

10. A method in accordance with any one of the embodiments 6 to 9,
wherein the generated instruction is automatically executed.

11. A method in accordance with any one of the preceding embodiments,
wherein a sorting and/or alignment device by means of which the products are handled in dependence on the at least one parameter is arranged upstream of at least one of the work stations with respect to the transport path.

12. A method in accordance with embodiment 11,
wherein the orientation of the products is changed by means of the sorting and/or alignment device.

13. A method in accordance with embodiment 11 or embodiment 12,
wherein the products are distributed over a plurality of tracks (S1, S2, S3) by means of the sorting and/or alignment device.

14. A method in accordance with embodiment 13,
wherein the products are guided in at least one of the tracks (S1, S2, S3) into a removal and/or checking region.

15. A method in accordance with embodiment 13 or embodiment 14,
wherein the products are guided in at least one of the tracks (S1, S2, S3) past at least one of the subsequent work stations.

16. A method in accordance with any one of the embodiments 13 to 15,
wherein the products are returned in at least one of the tracks (S1, S2, S3) to a work station arranged upstream of the sorting and/or alignment device or to a functional unit arranged upstream of the processing line.

17. A method in accordance with any one of the preceding embodiments,
wherein at least one functional unit arranged upstream of the processing line is provided and/or
wherein at least one functional unit arranged downstream of the processing line is provided,
wherein a control variable of the respective functional unit is adapted in dependence on the at least one parameter, and/or wherein at least one further parameter is determined at the respective functional unit and is considered at least one position of the processing line.

18. A method in accordance with embodiment 17,
wherein the at least one further parameter determined at a respective functional unit is considered at a position of the processing line in the same manner as the at least one parameter determined at the work station.

19. A method in accordance with any one of the preceding embodiments,
wherein a product store is provided which is arranged upstream of the processing line with respect to the transport path and in which the products are stored, wherein a control variable of the product store, in particular a cooling temperature, is adapted considering the at least one parameter, and/or wherein at least one further parameter, in particular a cooling temperature, is determined at the product store and is considered at least one position of the processing line.

20. A method in accordance with any one of the preceding embodiments,
wherein a packaging machine arranged downstream of the processing line with respect to the transport path, in particular a deep-draw packaging machine, is provided by means of which the processed products are packaged, wherein at least one control variable of the packaging machine is adapted in dependence on the at least one parameter, and/or wherein at least one further parameter is determined at the packaging machine and is considered at least one position of the processing line.

21. A method in accordance with any one of the preceding embodiments,
wherein a marking device is provided in which the products are marked, wherein the processing line comprises an identification device in which the marked products are detected.

22. A method in accordance with embodiment 21,
wherein at least one control variable of at least one work station is adapted in dependence on the detected product.

23. A method in accordance with any one of the preceding embodiments,
wherein an examination device by means of which at least one product feature is determined is arranged upstream of at least one work station with respect to the transport path.

24. A method in accordance with embodiment 23,
wherein the product feature is considered in the processing of the products at least one work station arranged downstream of the examination device.

25. A method in accordance with embodiment 23 or embodiment 24,
wherein the product feature is considered in the processing of the products at least one work station arranged upstream of the examination device.

26. A method in accordance with any one of the embodiments 23 to 25,
wherein the at least one product feature is considered at another position of the processing line in the same manner as the at least one parameter determined at the work station, and/or wherein the product feature is considered at another position of the processing line in the same manner as a further parameter determined at a functional unit arranged upstream or downstream of the processing line.

27. A method in accordance with any one of the preceding embodiments,
wherein one of the work stations of the processing line is a cooling device at which the products are cooled at a predefined or predefinable cooling temperature or at which the products are cooled to a predefined or predefinable temperature.

28. A method in accordance with embodiment 27,
wherein the cooling temperature and/or the dwell time is/are determined as a parameter at the cooling device.

29. A method in accordance with embodiment 27 or embodiment 28,
wherein the cooling temperature and/or the dwell time is/are adapted in dependence on at least one parameter determined at least one other work station.

30. A method in accordance with any one of the preceding embodiments,
wherein one of the work stations of the processing line is a pressing and/or shaping device at which the products are compressed and/or shaped.

31. A method in accordance with embodiment 30,
wherein the temperature of the products and/or forces occurring during the pressing, in particular pressing or return forces, and/or return paths are determined as parameters at the pressing and/or shaping device.

32. A method in accordance with embodiment 30 or embodiment 31,
wherein a control variable of the pressing and/or shaping device is adapted in dependence on a parameter determined at another work station.

33. A method in accordance with any one of the preceding embodiments,
wherein one of the work stations is a cutting apparatus, in particular an automatic slicer, at which the products are cut and/or divided into slices (39).

34. A method in accordance with embodiment 33,
wherein the temperature of the products and/or the degree of freezing of the products and/or the cutting forces are determined as a parameter at the cutting apparatus.

35. A method in accordance with embodiment 33 or embodiment 34,
wherein a control variable of the cutting apparatus is adapted in dependence on a parameter determined at another work station.

Further, in summary, the invention relates to the following embodiments of a system for processing food products:

1. A system for processing food products to be sliced and/or to be divided, in particular for processing fresh meat and/or bacon,
comprising a processing line, preferably for performing a method in accordance with any one of the embodiments 1 to 35 of a method for processing food products disclosed herein, that comprises a plurality of work stations and a single-track or multi-track transport device for transporting the products along a transport path from work station to work station,
wherein at least one of the work stations has a means for determining at least one parameter, wherein the means is connected to an evaluation and control device that is configured to generate a control signal in dependence on the at least one parameter.

2. A system in accordance with embodiment 1,
wherein the evaluation and control device is connected to a warning device that is configured to generate a warning message in dependence on the control signal.

3. A system in accordance with embodiment 1 or embodiment 2,
wherein the evaluation and control device is connected to a display device, wherein the display device is configured to display, in dependence on the control signal, an instruction for adapting at least one control variable of at least one work station.

4. A system in accordance with any one of the embodiments 1 to 3,
wherein the evaluation and control device is connected to at least one other work station, wherein the evaluation and control device is configured to automatically adapt at least one control variable of the at least one other work station by transmitting the control signal.

5. A system in accordance with any one of the embodiments 1 to 4,
wherein the evaluation and control device comprises a processor that is configured to execute a self-learning algorithm.

6. A system in accordance with any one of the embodiments 1 to 5,
wherein the processing line comprises at least one examination device for determining at least one product feature, wherein the examination device is connected to the evaluation and control device,
wherein the evaluation and control device is configured to generate a further control signal in dependence on the at least one product feature.

7. A system in accordance with any one of the embodiments 1 to 6,
wherein the processing line comprises a sorting and/or alignment device that is connected to the evaluation and control device, wherein the sorting and/or alignment device is configured to change the orientation of the products and/or to distribute the products over different tracks (S1, S2, S3) in dependence on the control signal.

8. A system in accordance with any one of the embodiments 1 to 7,
wherein the processing line comprises at least one functional path which branches off from the transport path, wherein—on the functional path—the products can be returned to a position of the transport path arranged upstream, and/or the products can be guided into a removal and/or checking region, and/or the products can be returned to a functional unit arranged upstream of the processing line.

9. A system in accordance with any one of the embodiments 1 to 8,
wherein at least one functional unit arranged upstream of the processing line is provided and is connected to the evaluation and control device, and/or wherein at least one functional unit arranged downstream of the processing line is provided and is connected to the evaluation and control device, wherein the evaluation and control device is configured to automatically adapt at least one control variable of the functional unit by transmitting the control signal to the respective functional unit, and/or wherein the respective functional unit has a further means for determining at least one further parameter, wherein the further means is connected to the evaluation and control device, wherein the evaluation and control device is configured to generate a corresponding control signal in dependence on the further parameter.

10. A system in accordance with any one of the embodiments 1 to 9,
wherein one of the work stations of the processing line is a cooling device for cooling the products.

11. A system in accordance with any one of the embodiments 1 to 10,
wherein one of the work stations of the processing line is a pressing and/or shaping device that comprises at least one movable contact element, in particular at least one punch, by means of which the products can be compressed and/or shaped.

12. A system in accordance with embodiment 11,
wherein the pressing and/or shaping device comprises a servomotor by which the at least one contact element can be driven.

13. A system in accordance with embodiment 11 or embodiment 12,
wherein the pressing and/or shaping device has at least one counter-element with which the at least one contact element cooperates to compress and/or to shape the product, wherein the counter-element and/or the contact element is/are at least partly variable in shape.

14. A system in accordance with any one of the embodiments 11 to 13,
wherein a cutting apparatus for slicing the products into slices, in particular an automatic slicer, is integrated into the pressing and/or shaping device.

15. A system in accordance with any one of the embodiments 11 to 14,
wherein the pressing and/or shaping device has a feed means that is configured to feed the products into a cutting plane of the cutting apparatus in which the products are cut into slices by means of a blade, in particular a rotating circular blade or scythe-like blade.

16. A system in accordance with any one of the embodiments 1 to 15,
wherein one of the work stations of the processing line is a cutting apparatus, in particular an automatic slicer, for cutting the products into slices and/or for dividing the products.

17. A system in accordance with any one of the embodiments 1 to 16,
wherein a packaging machine for packaging the processed products is arranged downstream of the processing line.

18. A system in accordance with any one of the embodiments 1 to 17,
wherein a product store is arranged upstream of the processing line.

The invention will be described purely by way of example in the following with reference to embodiment examples and to the drawings. They only represent possible embodiments of the invention, wherein further embodiments can be seen from the description and the claims.

There are shown:

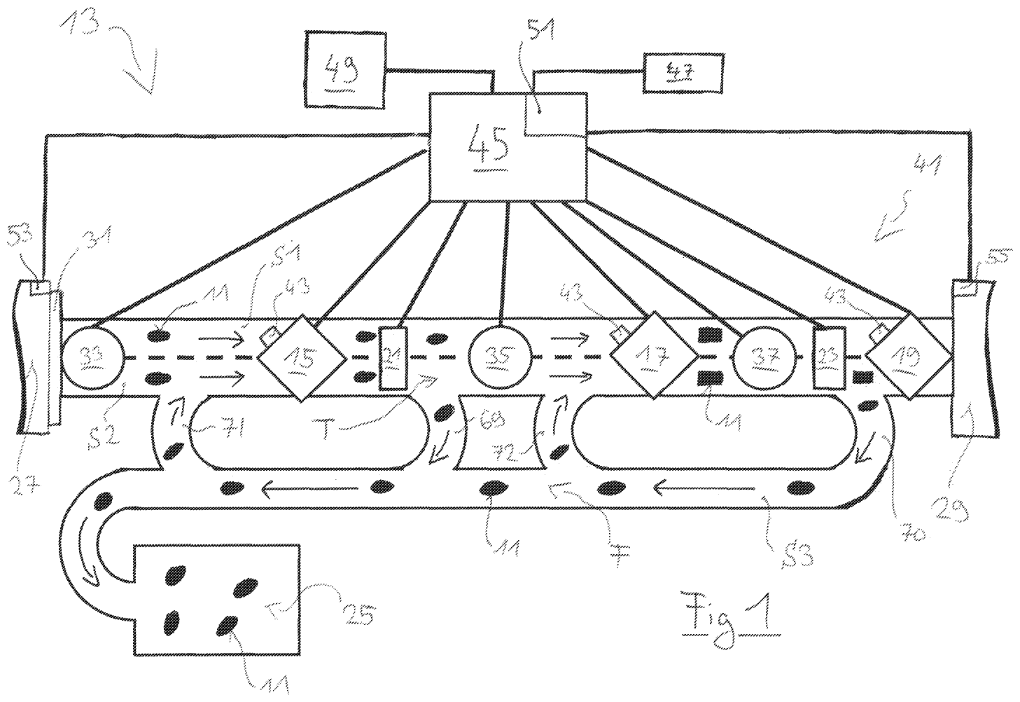

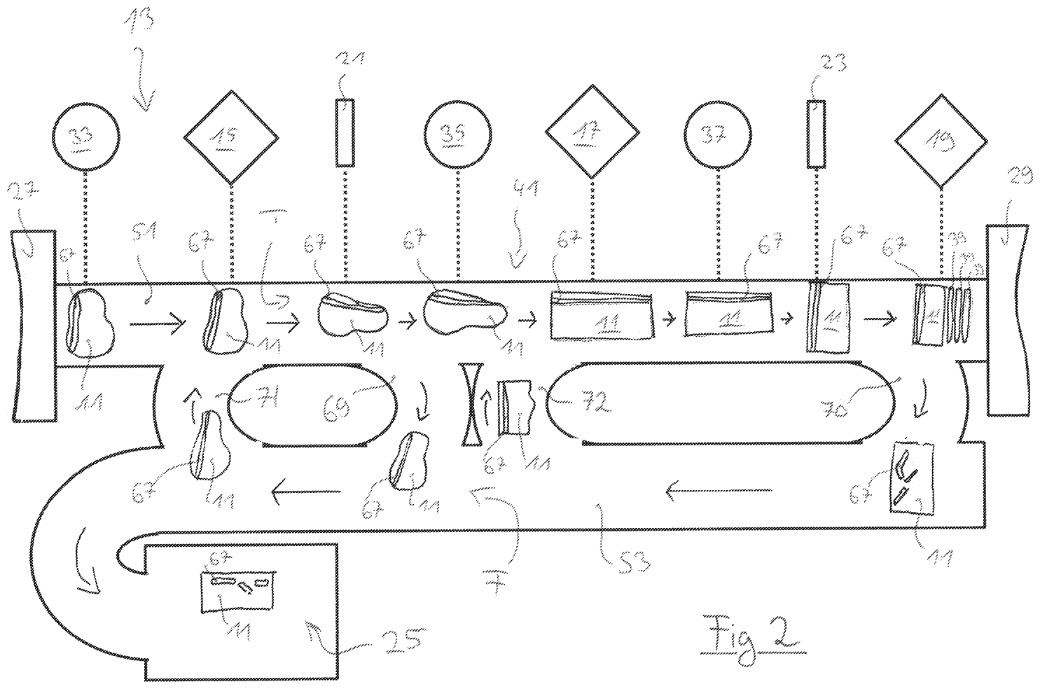

FIG. 1 a schematic representation of a system for processing products comprising a processing line having three work stations, three examination devices, and two sorting and/or alignment devices for illustrating the flexible control of such a system while considering determined parameters;

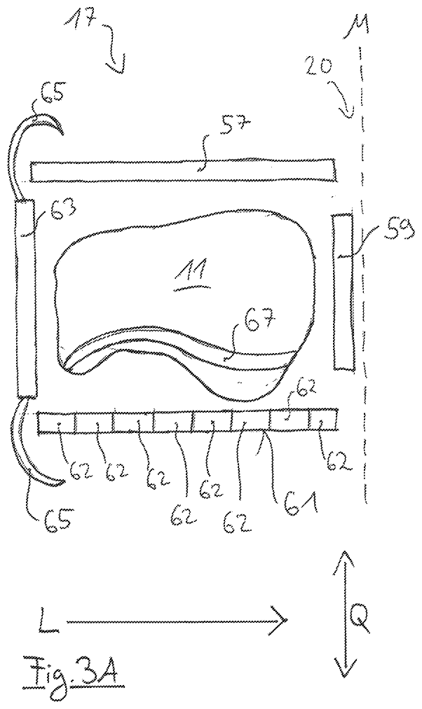

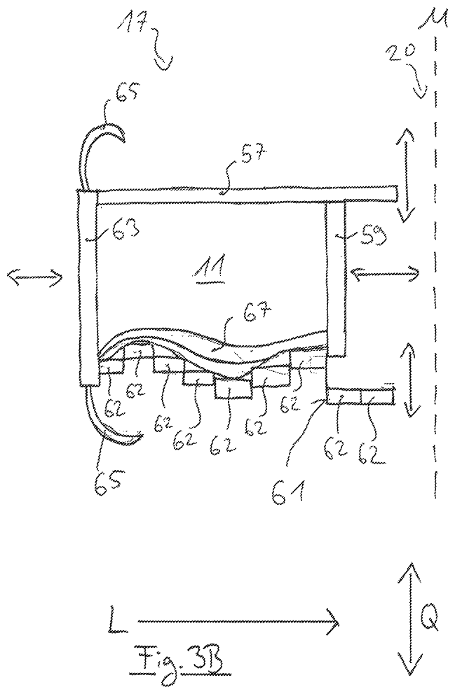

FIG. 2 a further schematic representation of a system for processing products comprising a processing line having three work stations, three examination devices, and two sorting and/or alignment devices with products moving along the transport path for illustrating possible processing steps and adaptations to be made; and

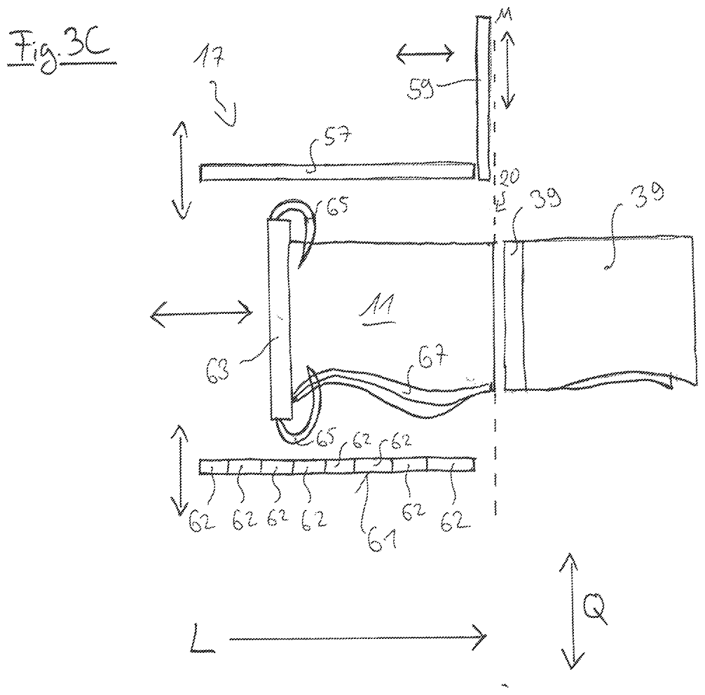

FIGS. 3A to 3C schematic representations of a pressing and/or shaping device, in particular as a possible work station of a processing line.

FIG. 1 shows a schematic representation of a system in accordance with the invention for processing products 11, said system comprising a processing line 13 that has three work stations 15, 17, and 19 that are each shown as a diamond. In this respect, the products 11 to be processed are transported in two tracks S1 and S2 by means of a transport device 41 along a transport path T from a work station 15 or 17 to a work station 17 or 19 arranged downstream. Furthermore, the work stations 15, 17, and 19 have at least one respective means 43 by which at least one parameter can be determined. Such a parameter can, for example, relate to a property of the product 11 or to a control variable of the respective work station 15, 17, or 19.

In addition to the work stations 15, 17, and 19, the processing line 13 comprises three circularly shown examination devices 33, 35, and 37 in which the products 11 are examined and at least one product feature is determined. Furthermore, two sorting and/or alignment devices 21 and 23 are provided at the processing line 13 and can, for example, serve to align the products 11 or to distribute the products 11 over different tracks S1 and S2 or to the track S3 of the functional path F. On this functional path F, the products 11 are conveyed against the direction of the transport path T, wherein the products 11 can move from the transport path T onto the functional path F via two branches 69 and 70 and can move from the functional path F to the transport path T via two feeds 71 and 72.

The system further comprises a functional unit 27 arranged upstream of the processing line 13 and a functional unit 29 arranged downstream of the processing line 13. A marking device 31, in which the products 11 are marked, is located directly upstream of the transport path T.

All of the work stations 15, 17, and 19, the examination devices 33, 35, and 37, and the sorting and/or alignment devices 21 and 23 are connected to an evaluation and control device 45 so that the mentioned components can generally both transmit information in the form of specific parameters or product features to the evaluation and control device 45 and receive control signals from said evaluation and control device 45. Similarly, the functional units 27 and 29 arranged upstream and downstream are also connected to the evaluation and control device 45 and have means 53 and 55 to determine parameters. The evaluation and control device 45 is in this respect configured to evaluate the information transmitted by all the devices and to generate one or more control signals in dependence thereon.

The evaluation and control device 45 is further connected to a warning device 47 and a display and input device 49, wherein the warning device 47 is configured to trigger a warning signal perceptible to a user in response to a control signal of the evaluation and control device 45. This can take place if a faulty processing is recognized based on the information or parameters transmitted from the further components to the evaluation and control device 45.

Specific indications or instructions for an adaptation of settings of one or more of the work stations 15, 17, or 19 to be made can additionally or alternatively be displayed on the display and input device 49 in that the evaluation and control device 45 transmits a control signal to that effect to the display and input device 49. Furthermore, a user can enter commands at the display and input device 49 to adapt the settings of the work stations 15, 17, or 19. Accordingly, due to the display of adaptations to be made at the display and input device 49 and to the possibility of directly entering commands, both the monitoring and the control of the operation of the processing line 13 can be performed by a user at a common location.

Consequently, the warning device 47 and the display and input device 49 enable a communication with the user so that the operation of the system can be considerably facilitated in that the user is assisted in this process by the indications and receives input or action requests. Thus, a processing as desired of the products 11 can also be ensured when the user operating the system does not have sufficient experience in the operation of the processing line 13 and the setting of the work stations 15, 17, and 19.

As already mentioned, the connection of the evaluation and control device 45 to the work stations 15, 17, and so 19 generally also allows them to be directly controlled and set by the evaluation and control device 45. This can enable an automatic and optimized operation in that the evaluation and control device 45 is configured to evaluate the information or parameters transmitted by the components of the processing line 13 as well as the functional unit arranged upstream 27 and the functional unit 29 arranged downstream and to perform the control while considering this information.

Such an automatic operation of the processing line 13 can in particular also take place only after an explicit enabling by a user if the evaluation and control device 45 is configured for this purpose so that the control of the operation can generally be incumbent on a user and the automatic operation only takes place when the release is granted. In this respect, provision can also be made that the evaluation and control device 45 can change predefined limit values for control variables of the work stations 15, 17, or 19 and can thus implicitly also consider external conditions in the control, wherein a release by the user can in particular take place for such a shifting of limit values. In this respect, such limit value adaptations can, for example, take place on the basis of detected trends or on the basis of statistics generated and evaluated by the evaluation and control device 45.

Furthermore, in the representation shown, a processor 51 that is configured to execute a self-learning algorithm is integrated into the evaluation and control device 45. Due to this processor, the control signals which the evaluation and control device 45 outputs can be optimized while considering the results of previously output control signals. In this respect, this optimization can take place with respect to the signals for controlling the warning device 49 to generate warning messages, with respect to the signals for controlling the display and input device 49, and/or with respect to the control signals transmitted directly to the work stations 15, 17, and 19.

This schematic representation of a system for processing products and in particular fresh meat merely serves to illustrate a possible design of such a system and the possibilities resulting in this respect for the communication and intelligent control by a linking of the components. However, the concepts in accordance with the invention presented in the present application can generally also be implemented by other arrangements of the components of the system, an omission of components, or an addition of further devices or other linkings.

As FIG. 1 shows, a functional unit 27 can be arranged upstream of the processing line 13. This functional unit can, for example, be a product store 27 in which the products 11 are cooled prior to the processing. Here, the product store 27 has at least one means 53 by which a parameter can be determined, wherein said parameter can in particular relate to the cooling temperature of the product store 27. Since the functional unit 27 arranged upstream is connected to the evaluation and control device 45, the determined parameter can in principle be considered in the processing of the products 11 at the work stations 15, 17, and 19 of the processing line 13. Conversely, settings can also be made at the functional unit 27 arranged upstream in dependence on a parameter determined within the processing line 13 in that said parameter is evaluated by the evaluation and control device 45 and a control signal is transmitted therefrom to the functional unit 27.

A marking device 31 is provided directly before the products 11 enter the processing line 13 in order to mark the products 11. For this purpose, a barcode can, for example, be applied to the products 11 by a stamp or a chip can be inserted so that the respective products 11 can be individually identified. In this respect, the identification of the products 11 can, for example, take place by means of an identification device 33 that here corresponds to the first examination device 33. However, the individual work stations 15, 17, and 19 can also have means for identifying the individual products 11 or an integrated identification device.

Such an identification of the products 11 enables a large amount of information on the specific product 11 to be as directly retrieved and transmitted to the evaluation and control device 45. The processing of the products 11 at the work stations 15, 17, and 19 can thereby, in principle, be performed individually adapted to the respective product 11. For example, due to the identification of a product 11, information on its weight, the size, or the dimensions of the product 11, as well as a fat or meat content, or also the surface property of the product 11 can be retrieved and can be accordingly considered in the processing.

The first work station 15 of the processing line 13 can in particular be a cooling device 15 for cooling the products 11 to optimally prepare the products 11 for the subsequent processing at the work stations 17 and 19. The second work station 17 can further be a pressing and/or shaping device 17 in which the products 11 are compressed and their shape is changed. The work station 19 can in particular be provided as a cutting apparatus 19 in which the products 11 are cut into slices 39 and portions are formed from these slices 39. Said portions can be forwarded to a functional unit 29 arranged downstream that can in particular be a packaging machine 29.

In the following, the possible communication and control of the system for processing products 11 will be described assuming a configuration of the work stations 15, 17, and 19 and of the functional units 27 and 29 as explained by way of example above. However, the system of these components represents only one possible embodiment, with further embodiments being possible that can in particular be seen from the description and the claims. Thus, other, additional or only some of the mentioned components can also be used in a system for processing products 11.

The work stations 15, 17, and 19 each have a means 43 by which at least one parameter can be determined that can be transmitted to the evaluation and control device 45. Such a means 43 can, for example, be a thermal imaging camera, a scanner, a scale, a laser thermometer, a camera for surface analysis, an image recognition program, or an X-ray device that can in particular be used to recognize the location of a bone.

The determined parameter can relate to the respective product 11 that is processed at the respective work station 15, 17, or 19 and that can in this respect relate to or be derived from a product feature such as the size or temperature of the product 11. Furthermore, the parameter can also reproduce a control variable or a value to which a control variable of the work stations 15, 17, or 19 can be set. Accordingly, the means 43 can also be configured to perform measurements in the operation of the respective work station 15, 17, or 19 in order, for example, to check the pressing forces by means of a force development measurement in the pressing and/or shaping device 17, whereby splintering bones can in particular be recognized. The cutting forces occurring during the cutting in the cutting apparatus 19 or other relevant values such as the cutting angle can likewise be determined and transmitted to the evaluation and control device 45.

Products 11 arriving on the processing line 13 from the product store 27 are first examined by means of the first examination device 33, wherein specific product features such as the size of the product 11, the product weight, the quality, the position or the alignment of the product 11, its temperature, fat or meat content, or the surface property of the product 11 can be determined. Furthermore, the transport duration of the products 11 from the product store 27 to the processing line 13 can, for example, be determined and transmitted to the evaluation and control device 45, with the evaluation and control device 45, for example, being able to cause an adaptation of the cooling temperature of the product store 27 based on said transport duration. For this purpose, the evaluation and control device 45 can, for example, control the warning device 47 connected to it in order to alert a user through a generated warning message to an adaptation to be made. Provision can further be made that the evaluation and control device 45 transmits a control signal to the display and input device 49 that displays an indication of a change to be made to the storage temperature and, if necessary, the optimal temperature to be set. In both cases, the operation of the processing line 13 by the user can be considerably simplified since the user neither has to perform the product examination himself nor has to have any particular experience to recognize and to make the necessary adaptation.

Provision can also be made that the evaluation and control device 45 automatically performs the necessary adaptation of the cooling temperature at the product store 27 in that the evaluation and control device 45 automatically transmits a control signal to the product store 27. In general, all of the subsequently described instructions for adapting the processing process can be automatically executed and/or can be transmitted to a user by means of the display and input device 49 and/or the warning device 47 so that the user can make the adaptation. In this respect, the resulting possibilities in particular depend on the provided components of the processing line 13 and on the design and connection of the evaluation and control device 45.

At the first examination device 33, the temperature of the products 11 can, for example, be determined and transmitted to the evaluation and control device 45. Based on the temperature of the products 11 determined by the examination device 33, the temperature of the product store 27 can, for example, subsequently be adapted in particular if it is detected that the products 11 do not move sufficiently cooled onto the processing line 13. Likewise, based on the measured temperature, the cooling temperature of the cooling device 15 arranged downstream can be adapted so that a possibly insufficient storage temperature at the product store 27 can be compensated. The dwell time of the products 11 in the cooling device 15 can also be adapted based on the determined temperature, whereby the cooling effect to be achieved during the processing in the cooling device 15 can likewise be adapted in dependence on the temperature of the products 11 determined by the examination device 33.

Similarly, the weight, the dimension, or the surface or the contour of the surface of the products 11 can be determined by means of the examination device 33 and an adaptation of the cooling temperature or of the dwell time of the products 11 at the cooling device 15 can be made on the basis of these parameters.

Following the first examination device 33, the products 11 move along the transport path T to the cooling device 15 at which further parameters of the product 11 can be determined by the means 43 and can be transmitted to the evaluation and control device 45. In this respect, the cooling temperature can in particular be transmitted and can, for example, be considered at the pressing and/or shaping device 17 in the setting of the pressing forces for compressing and shaping the product 11.

Furthermore, a sorting and/or alignment device 21 is provided which is arranged downstream of the cooling device 15 and by means of which the products 11 are handled. In this respect, the orientation of the products can in particular be changed to transport them further in the optimal alignment for the following processing at the pressing and/or shaping device 17 and to feed them to the latter. The alignment can in particular be adapted by rotating the products 11 or tilting them to one side so that a product 11 can, for example, be brought into an orientation such that that a bone 67 recognized at the examination device 33 is positioned in such a manner that a splintering of this bone 67 in the pressing and/or shaping device 17 can be prevented (cf. also FIGS. 2 and 3A to 3C).

Furthermore, the products 11 can be distributed over different tracks S1, S2, or S3 by means of the sorting and/or alignment device 21. In this respect, the tracks 51 and S2 are part of the transport path T, while the track S3 is associated with the functional path F that extends in the opposite direction to the functional path T.

Due to a distribution of the products 11 over the tracks S1 and S2 of the transport path T, it can, for example, be achieved that products 11 of an approximately equal total weight are transported in both tracks S1 and S2. Furthermore, a sorting of the products 11 can also take place in dependence on their quality so that the products 11 are fed depending on their quality to the cutting apparatus 19 where the products 11 are cut into slices 39 and portions are formed from at least one slice 39. The processed products 11 or the portions thus leave the processing line 13 sorted by their quality so that their further handling and, for example, packaging in the packaging machine 29 arranged downstream can likewise take place directly and in dependence on quality without a further examination.

The sorting of the products 11 in the sorting and/or alignment device 21 can in particular take place based on the dimension determined at the first examination device 33, the weight, or the surface contour of the products 11.

In addition to the distribution of the products 11 over the tracks S1 and S2 of the transport path T, they can also be distributed via the branch 69 to the track S3 of the functional path F, wherein the products 11 are transported on said track oppositely to the transport path T. Products 11 located on the functional path F can again be guided to the transport path T via the feed 71 so that the products 11 again reach the cooling device 15. It can be achieved by this feed 71 that products 11 that were initially not sufficiently cooled at the cooling device 15 can be processed by the latter again so that a satisfactory cooling can ultimately take place. In this respect, this return of a product 11 via the branch 69 and the feed 71 can in principle also take place a multiple of times and in particular so often until the desired cooling effect has been achieved at the cooling device 15.

Furthermore, the products 11 can be guided on the functional path F into a removal and/or checking region 25. Products 11 guided into this region can be checked by a user and can, if necessary, again be inserted onto the transport path T at a specific position of the processing line 13. Unusable or deficiently processed products 11 can furthermore be brought into a reject zone by the user after a check by the user.

In particular on an automatic control of the processing line 13 by the evaluation and control device 45, it is, however, also possible for the removal and/or checking region 25 to be an automatic reject zone and for no further check to take place by a user. In this respect, the evaluation and control device 45 or the processor 51 can comprise an ejection mode or can execute an ejection algorithm that reliably recognizes products 11 to be ejected, but still minimizes the product waste.

In principle, products 11 that have entered the removal and/or checking region 25 can also be fed directly therefrom to a further processing process that is not associated with the processing line 13 so that products 11 that are unsuitable for the processing along the processing line 13 can also be used and processed elsewhere.

Products 11 transported further by means of the transport device 41 from the sorting and/or alignment device 21 along the transport path T are conveyed to the second examination device 35, which is thus arranged directly upstream of the pressing and/or shaping device 17. In this examination device 35, the temperature of a product 11 or the temperature development along this product 11 can, for example, be determined and can be transmitted to the evaluation and control device 44. Based on these parameters, the cooling temperature of the cooling device 15 or the dwell time of the products 11 at the cooling device 15 can be adapted, for example. Equally, the degree of freezing of a product 11 or the crystallization at its surface can be determined in the examination device 35 and the cooling device 15 can be adapted in dependence thereon.

In this respect, a retroactive adaptation of the cooling device 15 takes place on the basis of the product features detected in the examination device 35, wherein ultimately the result of the cooling is checked and the cooling device 15 is set while considering this result to be able to optimally process subsequent products 11. Thus, both work stations 15, 17, or 19 arranged downstream and work stations 15 or 17 arranged upstream can be adapted based on a determined product feature so that as complete and flexible as possible a linking of the processing line 13 can be achieved.

Furthermore, the dimension or the surface contour of a product 11 can again be determined at the examination device 35 and the pressing and/or shaping device 17 arranged downstream can be set based thereon to provide an optimal processing of the products 11. In dependence on the parameters detected, the pressing forces occurring during the compression and/or shaping of the products 11 in the pressing and/or shaping device 17 or the process course can in particular be adapted with respect to the gradients of the pressing forces during the processing, for example. Equally, the optimal position of the product 11 in the pressing and/or shaping device 17 can be determined and the product 11 can be brought into this position so that the processing can be performed specifically adapted to the respective product 11.

The pressing and/or shaping device 17 can further have different contact elements 57, 59, 61, and 63 (cf. FIGS. 3A to 3C) by means of which a product 11 is compressed or shaped by a respective opposite movement of the contact elements 57 and 61 or 59 and 63 towards one another. In this respect, the pressing and/or shaping device 17 can have different types of such contact elements 57, 59, 61, and 63 that can in particular be of a punch-like design, wherein a suitable selection of these contact elements 57, 59, 61, and 63 can be provided for the compression or shaping of the respective product 11 on the basis of the parameters determined in the examination device 35. Due to this selection of the punches that is specifically coordinated with a specific product 11, a varying processing can also take place within a batch and is in each case individually and optimally coordinated with a respective product 11.

Furthermore, a bone located in a product 11 can be detected in the examination device 35 and its length, position, or diameter can be determined, for which purpose the examination device 35 can, for example, have an X-ray device. This information can also be transmitted to the evaluation and control device 45 that can thereupon set the pressing and/or shaping device 17 or prompt a user to make such a setting through a display at the display and input device 49 or a warning message at the warning device 47. In this respect, the pressing forces, their direction, or the force development can in particular be adapted during a compression of the products 11. Furthermore, the temperature of the product 11 or the temperature development along the product 11 can in turn be determined at the examination device 35 and can be considered at the pressing and/or shaping device 17.

During the processing of the products 11 at the pressing and/or shaping device 17, their temperature can also be determined and, based thereon, an adaptation of the cooling device 15 with respect to the cooling temperature or the dwell time of the products 11 in the cooling device 15 can be made by means of the evaluation and control device 45. The pressing forces occurring during a compression or the return forces acting on the contact elements 57, 59, 61, and 62 can also be determined and considered in the setting of the cooling temperature or of the dwell time at the cooling device 15. This retroactive communication from the pressing and/or shaping device 17 to the cooling device 15 is therefore in particular relevant since the temperature of the products 11 can be directly reflected in their deformability and the required pressing forces and the setting of the cooling device 15 can thus exert a direct influence on the processing of the products 11 at the pressing and/or shaping device 17.

Following the pressing and/or shaping device 17, the compressed or shaped products 11 move to a further examination device 37. At this examination device 37, the temperature or the temperature development along a product 11 can, for example, in turn be determined and transmitted to the evaluation and control device 45. The product feature determined at the examination device 37 can be considered in the setting of the cooling device 15. This product feature can also be used to change a setting of the pressing and/or shaping device 17 in order in particular to adapt a cooling of the products 11 that takes place before or during the processing at the pressing and/or shaping device 17.

Furthermore, a possible burr formation of the products 11 can be determined by means of the examination device 37 and, in dependence on said possible burr formation, the pressing and/or shaping device 17 can in particular be adapted with respect to the generated pressing forces, or the process sequence, or the force development. It can thereby be achieved that no cracks form in subsequent products 11 during the compression or shaping thereof and that uniform slices 39 can be produced by the cutting apparatus 19.

The surface contour of the compressed product 11 can also be determined by the examination device 37 and can be transmitted to the cutting apparatus 19 so that, for example, any necessary trimming of the respective product 11 can take place there or the cutting angle can be adapted to the contour of the product 11.

After the product examination by the examination device 37, the products 11 are transported to a further sorting and/or alignment device 23. The orientation or alignment of the products 11 can also be changed at this sorting and/or alignment device 23 to be able to feed them to the cutting apparatus 19 in an optimally aligned manner. A track distribution of the products 11 can likewise take place and unsatisfactorily processed products 11, in particular unsatisfactorily compressed or shaped products 11, can be distributed to the functional path F via the branch 70. Depending on the nature of the products 11, they can, for example, be fed to the pressing and/or shaping device 17 again via the feed 72 so that a desired result of the processing may be achieved. However, it is also possible to guide products 11 distributed by the sorting and/or alignment device 23 to the functional path F back to the transport path T initially via the feed 71 so that the respective product 11 passes through the total processing line 13 again from the cooling device 15.

Unusable products 11 or products 11 in which errors in the processing, such as a splintered bone 67, have been determined, can further be guided via the functional path F into the removal and/or checking region 25 and can be checked and, if necessary, separated out by a user there (cf. also FIG. 2).

In the final processing step along the processing line 13, the products 11 are cut into slices 39 by means of a cutting apparatus 19 and portions are formed from these slices 39 (cf. also FIG. 2 and FIG. 3C). In this respect, the cutting forces occurring can, for example, be determined during the cutting and can be transmitted to the evaluation and control device 45, whereupon an adaptation of the cooling device 15 can take place. This retroactive communication can again take account of the direct influence of the temperature on the cutting process.

The cutting speed within the cutting apparatus 19, wherein the cutting can, for example, take place by means of a revolving circular blade or scythe-like blade, can further be adapted based on a determined fat content of the respective product 11 that can already have been determined at the examination device 33.

A further examination of the cut slices 39 can be provided, wherein their temperature or the degree of freezing can, for example, be determined in the sense of a crystallization at the surface. These parameters can be considered at the cooling device 15 in that the cooling temperature or the dwell time of the products 11 at the cooling device 15 is adapted. On the basis of these parameters determined directly after the cutting, a possible cooling before or during the compression of the products 11 at the pressing and/or shaping device 17 can likewise be corrected. In this respect, this examination can, for example, take place at the slice surface directly before the cutting, at the cut-off and falling slices 39, or during the portion formation or their further transport.

The portions formed by means of the cutting apparatus 19 are transferred from the processing line 13 to the packaging machine 29 at which the portions are packaged. Such a packaging machine 29 can be configured as a deep-draw packaging machine, wherein depressions are drawn into a packaging film into which the portions are inserted. Furthermore, trays on which the portions are placed can be brought forward by the packaging machine 29.

The packaging machine 29 also has a means 55 to determine parameters related to the portions or the slices 39 or related to control variables of the packaging machine 29 and to transmit them to the evaluation and control device 45. These parameters can likewise be considered during the processing of the products 11 along the processing line 13. For example, the packaging machine 29 can communicate the dimensions of the provided packaging spaces to the evaluation and control device 45 that can thereupon set the pressing forces for compressing and shaping the products 11 at the pressing and/or shaping device 17 such that the slices 39 cut from the pressed products 11 and the portions formed therefrom can be packaged at the packaging spaces provided. Conversely, it is also possible that the packaging machine 29 is, for example, set based on the determined dimension of the products 11 and processes are controlled such that the resulting depressions of a deep-draw packaging machine have the required size to receive the cut products 11.

The system shown here for processing food products 11 to be sliced and/or to be divided, and in particular for processing fresh meat and/or bacon, enables a comprehensive linking of all the work stations 15, 17, and 19 involved in the processing, of the examination devices 33, 35, and 37, and of the sorting and/or alignment devices 21 and 23, and even a communication beyond the processing line 13 with the functional units 27 and 29 arranged upstream and downstream. In this respect, a large amount of information both on the products 11 and with respect to relevant settings of operating values in the region of the total processing line or of functional units 27 and 29 arranged upstream and downstream can be determined and the operation can be performed specifically adapted to the individual products 11 or specific operating situations.

In particular in the case of an automatic control of the processing line 13 by the evaluation and control device 45, no specific experience or expertise of a user is required in this respect so that the user only generally has to monitor the operation. The generation of signals perceptible to the user by, for example, an indication or an instruction at the display and input device 49 or a generated warning signal at the warning device 47 can also considerably facilitate the operation of the processing line 13. Furthermore, due to the consideration of the parameters determined at different positions of the processing line 13, the processing can be performed in an optimized manner at other positions of the processing line 13 and specifically adapted to the respective products 11 so that optimal results can be achieved.

In order furthermore to be able to constantly optimize the operation of the processing line 13, the evaluation and control device 45 can in particular have the mentioned processor 51 so that the control can, for example, take place by means of a self-learning algorithm. This can, for example, serve to optimize an adaptation of a control variable of one of the work stations 15, 17, or 19 that is generally to be made while considering adaptations that have already taken place. Accordingly, the results of previous adaptations are considered during the performance of further adaptations so that the automatic control of the processing line 13 can be increasingly and independently improved during the operation.

FIG. 2 shows a further schematic representation of a system for processing products and in particular for processing fresh meat along a processing line 13. This processing line 13 has the same components as the processing line 13 shown schematically in FIG. 1, wherein the products 11 are shown larger to illustrate the processes taking place and the transport path T comprises only one track S1.

In this respect, a product 11 conveyed from the product store 27 arranged upstream to the processing line 13 is to first examined by the examination device 33 and is forwarded to the cooling device 15 at which the product 11 is cooled and is prepared for the subsequent compression or shaping at the pressing and/or shaping device 17 and the cutting at the cutting apparatus 19. At the sorting and/or alignment device 21, the product 11 is aligned on the basis of the position of the bone 67 detected at the examination device 33 such that a breaking or splintering of this bone 67 can be prevented during the compression of the product 11 at the pressing and/or shaping device 17. Insufficiently cooled products 11 can in turn be distributed to the functional path F via the branch 69 and can, if necessary, be fed to the cooling device 15 again via the feed 71, while in particular unusable products 11 can be conveyed into the removal and/or checking region 25.

Along the transport path T, the products 11 are conveyed from the sorting and/or alignment device 21 via the examination device 35 to the pressing and/or shaping device 17 where the products 11 are compressed and/or shaped. In this respect, the pressing and/or shaping device 17 can also be configured to change the shape of the products 11 in a targeted manner and as desired so that a direct shaping of the products 11 can take place. In addition to the detected position of the bone 67, further parameters determined at the components of the processing line 13 arranged upstream and/or downstream can be considered at the pressing and/or shaping device 17 so that the processing can take place individually adapted to the respective product 11.

After the pressing and/or shaping device 17, the products 11 are again examined by means of the examination device 37 and are conveyed to a further sorting and/or alignment device 23. At the latter, a further change in the alignment of the products 11 can, for example, take place to forward them correctly to the cutting apparatus 19. For example, it is shown here that the respective product 11 is aligned by a further rotation so that slices 39 are cut at the cutting apparatus 19 that do not include any portion of the bone 67. Based on the detected and determined position of the bone 67, the cutting process can be interrupted by retracting the product 11 before a cutting into the bone 67 takes place so that the product residue can be ejected with the bone 67.

Furthermore, a branch 70, via which the products 11 can be distributed to the functional path F, is also provided downstream of the sorting and/or alignment device 23. In particular products 11 for which it could, for example, be determined on the basis of the pressing forces occurring during the compression at the pressing and/or shaping device 17 or on the basis of the development of said pressing forces that a bone 67 has splintered can be guided via the functional path F into the removal and/or checking region 25 and can be checked or ejected. Insufficiently compressed or unsatisfactorily shaped products 11 can further be fed to the pressing and/or shaping device 17 again via the feed 72 so that a desired result of the processing of the products 11 can ultimately be achieved at said pressing and/or shaping device 17.

FIGS. 3A to 3C show conceptual representations of an embodiment of a pressing and/or shaping device 17 for which protection is also claimed in the present application independently of the above-described system for processing products 11.

FIG. 3A shows a product 11 with a bone 67 that has been conveyed into the pressing and/or shaping device 17. Said pressing and/or shaping device 17 has four movable contact elements 57, 59, 61 and 63 that can, for example, be moved by means of a servomotor, not shown, to compress or to shape the product 11. To achieve a compression and to influence the shape of the product 11, the contact elements 59 and 63 can be moved against or along the longitudinal direction L, while the contact elements 57 and 61 are movable with respect to one another in the transverse direction Q. Accordingly, a respective one of the contact elements 57 and 61 or one of the contact elements 59 and 63 forms a respective counter-element 57, 59 (61, 63) of the other contact element 61, 63 (57, 59) that cooperate to compress a product 11 and to change its shape. Furthermore, the pressing and/or shaping device 17 can have further contact elements or counter-elements that are, for example, movable perpendicular to the longitudinal direction L and the transverse direction Q to be able to compress or shape the products 11 in this direction as well.

Directly connected to the contact element 59 in the longitudinal direction L is a cutting plane M in which a blade 20 is moved to cut the product 11 into slices 39. This blade 20 can in particular be configured as a revolving circular or scythe-like blade. Due to the direct connection of the cutting plane M, a slicing apparatus is integrated into the pressing and/or shaping device 17 and the pressing and/or shaping device 17 has an integrated slicer. Thus, the cutting apparatus 19 of FIGS. 1 and 2 are here directly integrated into the pressing and/or shaping device 17.

To allow a feeding of the product 11 into the cutting plane M after the compression or shaping, the contact element 63 displaceable in the longitudinal direction has two gripper arms 65 by means of which the product 11 can be gripped and can be held during the feed. The contact element 63 can thus advantageously satisfy a dual function in that it serves both for the compression or shaping of the product 11 and as a feed element 63 for feeding said product 11 into the cutting plane M.

Provision can generally also be made to hold the product 11 by means of the gripper arms 65 or other means even before the compression or shaping and to cut said product 11 to size by cutting means, not shown, that usually differ from the blade 20. A reduction in the size of the product 11 can thereby, for example, be achieved that is not possible by just a compression due to the maximum achievable forces at the contact elements 57, 59, 61, and 63. Furthermore, possibly detected deficient margins of the products 11 can be removed in this manner.

FIG. 3B shows the product 11 during the compression and/or shaping by the contact elements 57, 59, 61, and 63. During this compression, the gripper arms 65 of the contact element 63 are displaced outwardly so that the contact element 63 can also be used to compress and shape the product 11.

As will further become clear, the contact element 61 comprises a plurality of part elements 62 by which the contact element 61 is formed with a variable shape. By means of these part elements 62, the contact element 61 can be adapted to the contour of the product 11 and in particular to the shape of the bone 67 so that a breaking and splintering of this bone 67 can be prevented during the compression of the product 11. In this respect, provision can in particular be made that the part elements 62 are already aligned automatically adapted to the course of this bone 67 on the basis of a previously detected position of the bone 67 before the product 11 enters the pressing and/or shaping device 17. Furthermore, provision can also be made that the part elements 62, as indicated here, automatically adapt to the shape of the product 11 or of the bone 67 due to a pressure arising during the compression.

Since the contact element 61 of variable shape or its part elements 62 can be configured as directly controllable, they can generally also be brought into a predefined or predefinable position before the compression of a product 11 in order thereby to directly act on the contour of the compressed product 11. The product 11 can thereby be brought into a desired shape during the compression, wherein any contour can, in principle, be generated by the change of the shape of the contact element 61 and the contours that can be generated are not limited to rectilinear shapes. For this purpose, provision can in particular be made to form further or all of the contact elements 57, 59, and 63 as uniformly variable in shape.

In addition to the design of the contact element 61 shown here with a plurality of displaceable part elements 62, provision can also be made that the contact element 61 is produced from an elastic material so that a single-part contact element 61 can adapt to the structure of the product 11. Furthermore, the contact element 61 or specific part regions thereof can be covered by a cushion filled, for example, with a gas, in particular also with air, or with a gel so that a change in shape of the contact element 61 or its surface for an adaptation to a contour of a product 11 can take place due to a pressure on this cushion.

As FIG. 3C shows, after the completion of the compression or shaping of the product 11, the gripper arms 65 can engage into the product 11 to enable a holding or a feed of the product 11 into the cutting plane M. For this purpose, the gripper arms 65 can, for example, be pivotably arranged at the contact element 63, wherein a retraction of the gripper arms 65 against the longitudinal direction L during the compression and a subsequent extension are also conceivable. Furthermore, a gripper can, for example, be formed with one or more barbs that already engage into the product 11 during the compression or shaping.

To enable a feed of the product 11 into the cutting plane M, the contact element 59 can in particular also be moved in the transverse direction Q to clear the path for the product 11 in the longitudinal direction L. Furthermore, the contact element 57 can be displaceable in the transverse direction Q such that the product 11 can be pushed in the transverse direction Q from a transport path T onto a functional path F and can, for example, be guided into a removal and/or checking region 25 (cf. FIGS. 1 and 2). Despite the compact design without a separate transport region between the pressing and/or shaping device 17 and the cutting plane M, it can thereby be achieved that products 11 recognized as unusable can be sorted out in a simple manner and without further devices.

Due to this integration of the cutting apparatus 19 into the pressing and/or shaping device 17, a particularly space-saving design can thus be achieved and the pressing and/or shaping device 17 can be used in a variety of ways. In this respect, only the concept of such a pressing and/or shaping device 17 with an integrated cutting apparatus is also to be illustrated by the embodiment shown here.

### REFERENCE NUMERAL LIST

11 product
13 processing line
15 first work station, cooling device
17 second work station, pressing and/or shaping device
19 third work station, cutting apparatus
20 blade
21 first sorting and/or alignment device
23 second sorting and/or alignment device
25 removal and/or checking region
27 functional unit arranged upstream, product store
29 functional unit arranged upstream, packaging machine
31 marking device
33 identification device, first examination device
35 second examination device
37 third examination device
39 product slice
41 transport device
43 means
45 evaluation and control device
47 warning device
49 display and input device
51 processor
53 means of the functional unit arranged upstream
55 means of the functional unit arranged downstream
57 first contact element, first counter-element
59 second contact element, second counter-element
61 third contact element, third counter-element
62 part element of variable shape
63 fourth contact element, fourth counter-element, feed means
65 gripper arm
67 bone
69 first branch
70 second branch
71 first feed
72 second feed
F functional path
L longitudinal direction
M cutting plane
Q transverse direction
S1 first track
S2 second track
S3 track of the functional path
T transport path

1. A system for processing food products to be sliced or to be divided,
comprising a processing line that comprises a plurality of work stations and a single-track or multi-track transport device for transporting the products along a transport path from work station to work station,
wherein at least one of the work stations has a means for determining at least one parameter, wherein the means is connected to an evaluation and control device that is configured to generate a control signal in dependence on the at least one parameter.

2. A system in accordance with claim 1,
wherein the parameter relates to at least one of a feature of the product or a control variable of the one work station.

3. A system in accordance with claim 1,
wherein the evaluation and control device is connected to a warning device that is configured to generate a warning message in dependence on the control signal.

4. A system in accordance with claim 1,
wherein the evaluation and control device is connected to a display device,
wherein the display device is configured to display, in dependence on the control signal, an instruction for adapting at least one control variable of at least one work station.

5. A system in accordance with claim 1,
wherein the evaluation and control device is connected to at least one other work station,
wherein the evaluation and control device is configured to automatically adapt at least one control variable of the at least one other work station by transmitting the control signal.

6. A system in accordance with claim 1,
wherein the evaluation and control device comprises a processor that is configured to execute a self-learning algorithm.

7. A system in accordance with claim 1,
wherein the processing line comprises at least one examination device for determining at least one product feature,
wherein the examination device is connected to the evaluation and control device,
wherein the evaluation and control device is configured to generate a further control signal in dependence on the at least one product feature.

8. A system in accordance with claim 1,
wherein the processing line comprises a sorting and/or alignment device that is connected to the evaluation and control device,
wherein the sorting and/or alignment device is configured to at least one of changing the orientation of the products or distributing the products over different tracks in dependence on the control signal.

9. A system in accordance with claim 1,
wherein the processing line comprises at least one functional path which branches off from the transport path, wherein—on the functional path—the products can be returned to a position of the transport path arranged upstream, or the products can be guided into a removal region or a checking region, or the products can be returned to a functional unit arranged upstream of the processing line.

10. A system in accordance with claim 1,
wherein at least one functional unit arranged upstream or downstream of the processing line is provided and is connected to the evaluation and control device,
wherein the evaluation and control device is configured to automatically adapt at least one control variable of the functional unit by transmitting the control signal to the respective functional unit,

11. A system in accordance with claim 1,
wherein at least one functional unit arranged upstream or downstream of the processing line is provided and is connected to the evaluation and control device,
wherein the respective functional unit has a further means for determining at least one further parameter,
wherein the further means is connected to the evaluation and control device,
wherein the evaluation and control device is configured to generate a corresponding control signal in dependence on the further parameter.

12. A system in accordance with claim 1,
wherein one of the work stations of the processing line is a cooling device for cooling the products.

13. A system in accordance with claim 1,
wherein one of the work stations of the processing line is a pressing and/or shaping device that comprises at least one movable contact element by means of which the products can be compressed or shaped.

14. A system in accordance with claim 13,
wherein the pressing and/or shaping device comprises a servomotor by which the at least one contact element can be driven.

15. A system in accordance with claim 13,
wherein the pressing and/or shaping device has at least one counter-element with which the at least one contact element cooperates to compress or to shape the product, wherein at least one of the counter-element or the contact element is at least partly variable in shape.

16. A system in accordance with claim 13,
wherein a cutting apparatus for slicing the products into slices is integrated into the pressing and/or shaping device.

17. A system in accordance with claim 16,
wherein the pressing and/or shaping device has a feed means that is configured to feed the products into a cutting plane of the cutting apparatus in which the products are cut into slices by means of a blade.

18. A system in accordance with claim 1,
wherein one of the work stations of the processing line is a cutting apparatus for cutting the products into slices and/or for dividing the products.

19. A system in accordance with claim 1,
wherein a packaging machine for packaging the processed products is arranged downstream of the processing line.

20. A system in accordance with claim 1,
wherein a product store is arranged upstream of the processing line.
